(19) United States
(12) Patent Application Publication
(10) Pub. No.: US 2021/0358665 A1
(43) Pub. Date: Nov. 18, 2021

(54) SOFT MAGNETIC COMPOSITION, SINTERED BODY, COMPOSITE BODY, PASTE, COIL COMPONENT, AND ANTENNA

(71) Applicant: Murata Manufacturing Co., Ltd., Nagaokakyo-shi (JP)

(72) Inventor: Terunobu Ishikawa, Nagaokakyo-shi (JP)

(21) Appl. No.: 17/388,373

(22) Filed: Jul. 29, 2021

Related U.S. Application Data
(63) Continuation of application No. PCT/JP2020/003262, filed on Jan. 29, 2020.

(30) Foreign Application Priority Data
Feb. 8, 2019 (JP) 2019-021617

(51) Int. Cl. H01F 1/34; H01F 27/28; H01F 27/255

(52) U.S. Cl. CPC H01F 1/348; H01F 27/255; H01F 27/28

(57) ABSTRACT

A soft magnetic composition that includes W-type hexagonal ferrite as a main phase with metal element ratios of: Ba+Sr+Na+K+La:4.7 mol % to 5.8 mol %, where; Ca:0.2 mol % to 5.0 mol %; Fe:72.5 mol % to 86.0 mol %; Co:7.0 mol % to 15.5 mol %; and D:7.0 mol % to 14.8 mol % when: Me(I)=Li+Na+K, Me(II)=Co+Cu+Mg+Mn+Ni+Zn, Me(IV)=Ge+Si+Sn+Ti+Zr+Hf, Me(V)=Mo+Nb+Ta+Sb+W+V, and D=Me (I)+Me(II)−Me (IV)−2×Me (V), and the soft magnetic composition has a coercivity Hcj of 40 kA/m or less.

### CROSS REFERENCE TO RELATED APPLICATIONS

The present application is a continuation of International application No. PCT/JP2020/003262, filed Jan. 29, 2020, which claims priority to Japanese Patent Application No. 2019-021617, filed Feb. 8, 2019, the entire contents of each of which are incorporated herein by reference.

### FIELD OF THE INVENTION

The present invention relates to a soft magnetic composition, a sintered body, a composite body, a paste, a coil component, and an antenna.

### BACKGROUND OF THE INVENTION

Magnetic materials such as ferrite materials are widely used as materials for components, such as inductors, antennas, noise filters, and radio wave absorbers. These components use the characteristics of the permeability μ′, which is the real component of the complex magnetic permeability μ of the magnetic material, or the magnetic loss μ″, which is the imaginary component of the complex magnetic permeability μ of the magnetic material, according to the intended use. For example, inductors and antennas require high permeability μ′. Furthermore, it is also preferable that the inductors and antennas have low magnetic loss μ″; thus, the value Q, which is the W/μ″ ratio, is also required to be high.

In recent years, the frequency band used by electronic appliances has become higher, and magnetic materials that satisfy the characteristics required in the GHz band have been in demand.

For example, Patent Document 1 discloses, as one example of magnetic materials used in inductors and antennas, a soft magnetic ferrite material having low coercivity.

Patent Document 1 discloses a composite magnetic material obtained by dispersing, in a resin, a magnetic oxide that contains 16 mol % to 20 mol % of cobalt oxide on a CoO basis, 71 mol % to 75 mol % of iron oxide on a Fe₂O₃ basis, and the balance containing at least one selected from BaO and SrO, and has Co-substituted W-type hexagonal ferrite as a main phase.

Patent Document 1: Japanese Unexamined Patent Application Publication No. 2010-238748

### SUMMARY OF THE INVENTION

In Patent Document 1, a composite magnetic material having decreased magnetic loss is prepared by dispersing particles having a hexagonal ferrite single domain structure in the resin to keep the single domain structure. Patent Document 1 describes that when W-type hexagonal ferrite is used as hexagonal ferrite and control factors, such as the amount of W-type hexagonal ferrite loaded into a resin, the porosity, and the particle diameter, are adjusted, the permeability can be increased and the magnetic loss and the dielectric loss can be decreased while suppressing the increase in the dielectric constant of the composite magnetic material prepared as such.

Furthermore, Patent Document 1 describes that when the specific resistance of the composite magnetic material is small, the magnetic loss increases and the bandwidth narrows, and that, for this reason, the specific resistance of the composite magnetic material is preferably 1.0×10¹² Ωcm or more.

However, in Patent Document 1, the magnetic oxide in a state not yet having been dispersed in the resin is not considered to sufficiently satisfy all characteristics such as specific resistance, permeability in GHz bands, and Q. Thus, under present circumstances, a soft magnetic material that has high specific resistance as well as high permeability and high Q in the GHz bands has not been obtained.

The present invention has been made to resolve the issues described above and aims to provide a soft magnetic composition that has high specific resistance as well as high permeability and high Q in the GHz band. The present invention also aims to provide a sintered body, a composite body, and a paste that use the soft magnetic composition, and a coil component and an antenna that use the sintered body, the composite body, or the paste.

The soft magnetic composition of the present invention is an oxide that contains W-type hexagonal ferrite as a main phase and has the below metal element ratios. The soft magnetic composition also has a coercivity Hcj of 40 kA/m or less.

A total of Ba+Sr+Na+K+La: 4.7 mol % to 5.8 mol %, where Ba: 0 mol % to 5.8 mol %, Sr: 0 mol % to 5.8 mol %, Na: 0 mol % to 5.2 mol %, K: 0 mol % to 5.2 mol %, and La: 0 mol % to 2.1 mol %,

Ca: 0.2 mol % to 5.0 mol %,

Fe: 72.5 mol % to 86.0 mol %,

Li: 0 mol % to 2.6 mol %,

Co: 7.0 mol % to 15.5 mol %,

D: 7.0 mol % to 14.8 mol % when: Me(I)=Li+Na+K, Me(II)=Co+Cu+Mg+Mn+Ni+Zn, Me(IV)=Ge+Si+Sn+Ti+Zr+Hf, Me(V)=Mo+Nb+Ta+Sb+W+V, and D=Me (I)+Me (II)−Me (IV)−2×Me(V),

Cu: 0 mol % to 2.6 mol %,

Mg: 0 mol % to 2.6 mol %,

Mn: 0 mol % to 2.6 mol %,

Ni: 0 mol % to 5.2 mol %,

Zn: 0 mol % to 2.6 mol %,

Ge: 0 mol % to 2.6 mol %,

Si: 0 mol % to 2.6 mol %,

Ti: 0 mol % to 2.6 mol %,

Sn: 0 mol % to 5.2 mol %,

Zr+Hf: 0 mol % to 5.2 mol %,

Al: 0 mol % to 5.2 mol %,

Ga: 0 mol % to 5.2 mol %,

In: 0 mol % to 7.8 mol %,

Sc: 0 mol % to 7.8 mol %,

Mo: 0 mol % to 2.6 mol %,

a total of Nb+Ta: 0 mol % to 2.6 mol %,

Sb: 0 mol % to 2.6 mol %,

W: 0 mol % to 2.6 mol %, and

V: 0 mol % to 2.6 mol %.

A sintered body of the present invention is obtained by firing the soft magnetic composition of the present invention.

A composite body or a paste of the present invention is obtained by mixing the soft magnetic composition of the present invention and a nonmagnetic body such as glass or resin.

A coil component of the present invention includes a core portion and a winding portion disposed around the core portion. The core portion is formed by using the sintered body, composite body, or paste of the present invention, and the winding portion always contains an electrical conductor such as silver or copper. An antenna of the present invention is formed by using the sintered body, composite body, or paste of the present invention and an electrical conductor such as silver or copper.

The present invention can provide a soft magnetic composition that has high specific resistance as well as high permeability and high Q in the GHz band.

### BRIEF DESCRIPTION OF THE DRAWINGS

FIG. 1 is a schematic view illustrating a crystal structure of W-type hexagonal ferrite.

FIG. 2 illustrates XRD peak intensity ratios of calcined powders having a compositional formula: BaCaₓCo₂Fe₁₆O_{27-δ} with varied Ca contents x.

FIG. 3 illustrates XRD peak intensity ratios of calcined powders having a compositional formula: BaCa_{0.3}Co_{y}Fe₁₆O_{27-δ} with varied Co contents y.

FIG. 4 illustrates the XRD peak intensity ratios of calcined powders having a compositional formula: BaCa_{0.3}Co₂Fe₂ₘO_{27-δ} with varied Fe contents 2m.

FIG. 5 illustrates a surface SEM image of a sintered body having a compositional formula BaCa_{0.3}Co₂Fe₁₆O₂₇.

FIG. 6 is a graph illustrating the influence of the Ca content on the frequency characteristics of permeability for compositional formula BaCaₓCo₂Fe₁₆O_{27-δ}.

FIG. 7 is a graph illustrating the influence of the Co content on the frequency characteristics of permeability for compositional formula BaCa_{0.3}CoxFe₁₆O_{27-δ}.

FIG. 8 is a graph illustrating the influence of Ba-site Sr substitution on the frequency characteristics of permeability for compositional formula (Ba₁₋ₓSrₓ)Ca_{0.3}CO₂Fe₁₆O_{27-δ}.

FIG. 9 is a graph illustrating the frequency characteristics of permeability acquired by Co-site Ni substitution for compositional formula BaCa_{0.3}(Co₂₋ₓNiₓ)Fe₁₆O_{27-δ}.

FIG. 10 is a graph illustrating the frequency characteristics of permeability acquired by Co-site Zn substitution for compositional formula BaCa_{0.3}(Co₂₋ₓZnₓ)Fe₁₆O_{27-δ}.

FIG. 11 is a graph illustrating the frequency characteristics of permeability acquired by Fe-site Co—Si composite substitution for compositional formula BaCa_{0.3}Co₂₊ₓSiₓFe₁₆₋₂ₓO_{27-δ}.

FIG. 12 is a graph illustrating the frequency characteristics of permeability acquired by Fe-site Co—(Zr+Hf) composite substitution for compositional formula BaCa_{0.3}CO₂+ₓ (Zr+Hf)ₓFe₁₆₋₂ₓO_{27-δ}.

FIG. 13 is a graph illustrating the frequency characteristics of permeability acquired by Fe-site Sc substitution for compositional formula BaCa_{0.3}Co₂(Fe₁₆₋ₓScₓ)O_{27-δ}.

FIG. 14 is a schematic perspective view of one example of a winding coil.

FIG. 15 is a graph illustrating frequency characteristics of coil inductance L.

FIG. 16 is a graph illustrating frequency characteristics of Q of the coil.

FIG. 17 is a schematic perspective view of one example of a laminated coil.

FIG. 18 is a schematic perspective view of another example of a laminated coil.

FIG. 19 is a schematic perspective view of one example of an antenna.

FIG. 20 is a schematic perspective view of another example of an antenna.

### DETAILED DESCRIPTION OF THE PREFERRED EMBODIMENTS

A soft magnetic composition, a sintered body, a composite body, a paste, a coil component, and an antenna of the present invention will now be described.

It is to be understood that the present invention is not limited by the features below, and can be applied with appropriate modifications without departing from the gist of the present invention. Any combination of two or more individual preferable features described below is also within the scope of the present invention.

[Soft Magnetic Composition]

A soft magnetic composition of the present invention has W-type hexagonal ferrite as a main phase.

The soft magnetic composition of the present invention refers to soft ferrite as defined in JIS R 1600.

The main phase of the soft magnetic composition of the present invention refers to a phase that is most abundant. Specifically, the case where the W-type hexagonal ferrite is the main phase is defined as when all of the following five conditions are satisfied when a non-oriented powder of the W-type hexagonal ferrite is measured. (1) When the total of the peak intensity ratios of peaks at lattice spacing=4.11, 2.60, 2.17 [nm] (when a copper wire source X-ray is used, these are diffraction angle 2θ=21.6, 34.5, 41.6°: Note these lattice spacings and the diffraction angles are on the basis of hexagonal ferrite constituted solely by Ba, Co, Fe, and O, and the lattice spacings narrow when the lattice constant decreases due to substitution elements and widen when the lattice constant increases due to substitution elements) around which peaks derived from non-W-type hexagonal ferrites and having an intensity of 10% or more are absent is defined as A, A exceeds 80%. (2) The peak intensity ratio of a peak at lattice spacing=2.63 [nm] (when a copper wire source X-ray is used, this is diffraction angle 2θ=34.1°) around which peaks derived from non-M-type hexagonal ferrites and having an intensity of 10% or more are absent is less than 80%. (3) The peak intensity ratio of a peak at lattice spacing=2.65 [nm] (when a copper wire source X-ray is used, this is diffraction angle 2θ=33.8°) around which peaks derived from non-Y-type hexagonal ferrites and having an intensity of 10% or more are absent is less than 30%. (4) The peak intensity ratio of a peak at lattice spacing=2.68 [nm] (when a copper wire source X-ray is used, this is diffraction angle 2θ=33.4°) around which peaks derived from non-Z-type hexagonal ferrites and having an intensity of 10% or more are absent is less than 30%. (5) The peak intensity ratio of a peak at lattice spacing=2.53 [nm] (when a copper wire source X-ray is used, this is diffraction angle 2θ=35.4°), which is a main peak of spinel ferrite, is less than 90%. The soft magnetic composition of the present invention may have W-type hexagonal ferrite single phase, in other words, the molar ratio of the W-type hexagonal ferrite phase may be substantially 100%.

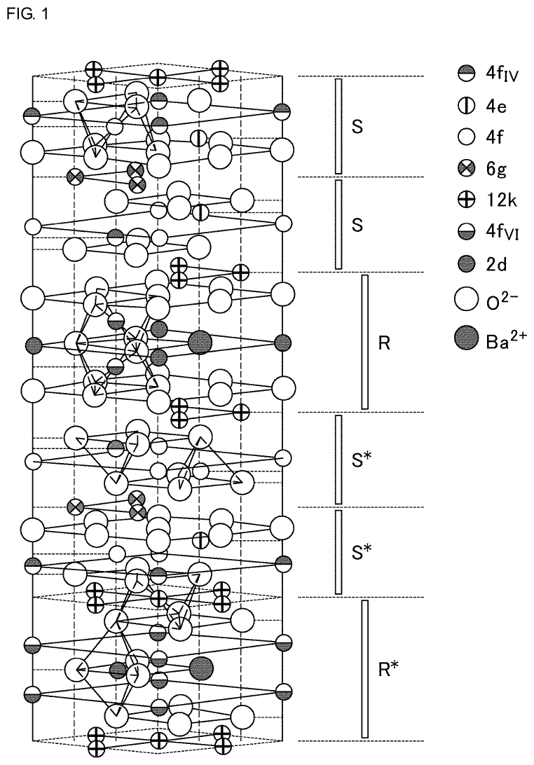

FIG. 1 is a schematic view illustrating a crystal structure of W-type hexagonal ferrite. FIG. 1 illustrates the crystal structure of Ba²⁺Fe²⁺₂Fe₁₆O₂₇.

The crystal structure of the W-type hexagonal ferrite is represented by structural formula: A²⁺Me²⁺₂Fe₁₆O₂₇, and is a stacking structure of S-blocks and R-blocks in the c-axis direction. In FIG. 1, * indicates blocks rotated 180° with respect to the c-axis.

Known crystal structures of hexagonal ferrites are W-type, M-type, Y-type, and Z-type. Among these, W-type features a higher saturation magnetization Is than M-type, Y-type, and Z-type. This is because there are three crystal factors, R-block, S-block, and T-block, to be combined, W-type has crystal factors SSR, M-type has crystal factors SR, Y-type crystal factors ST, and Z-type has crystal factors RTST, but W-type has no T-crystal factor having saturation magnetization=0 but has two S-crystal factors having the highest saturation magnetization. Thus, it is considered that high permeability can be obtained at high frequencies since the saturation magnetization Is can be increased from the Snoek's formula of hexagonal ferrite: fᵣ×(μ−1)=(γIs)+(6πμ₀)×{√(H_{A1}/H_{A2})+√(H_{A2}/H_{A1})}, and the resonant frequency fᵣ can be increased. In the Snoek's formula of hexagonal ferrite, the resonant frequency fᵣ is the frequency of the local maximum of the magnetic loss μ″, μ is permeability, γ is gyromagnetic ratio, Is is saturation magnetization, μ₀ is vacuum permeability, H_{A} is anisotropic magnetic field, H_{A1} is anisotropic magnetic field in one direction, and H_{A2} is anisotropic magnetic field in two directions, and the directions are set to maximize the difference between H_{A1} and H_{A2}. Hexagonal ferrite features that the difference between H_{A1} and H_{A2} is notably large, namely, one is at least ten times greater than the other.

In the soft magnetic composition of the present invention, from the viewpoint of increasing the resonant frequency by increasing the saturation magnetization, W-type hexagonal ferrite is preferably single phase. However, small amounts of different phases such as M-type hexagonal ferrite, Y-type hexagonal ferrite, Z-type hexagonal ferrite, and spinel ferrite may also be contained.

The soft magnetic composition of the present invention is an oxide that has the following metal element ratios.

In this description, a notation such as “Ba+Sr” refers to the total of the respective elements.

In addition, compositions described below are compositions of magnetic bodies, and when inorganic glass or the like is added, the resulting mixture is treated as a composite matter described below.

The contents of the respective elements contained in the soft magnetic composition can be determined by compositional analysis by inductively coupled plasma atomic emission spectroscopy (ICP-AES).

<1> Essential elements (Ba+Sr+Na+K+La: 4.7 mol % to 5.8 mol %, Ba: 0 mol % to 5.8 mol %, Sr: 0 mol % to 5.8 mol %, Na: 0 mol % to 5.2 mol %, K: 0 mol % to 5.2 mol %, La: 0 mol % to 2.1 mol %)

In order to constitute A-site elements that correspond to Ba sites of the crystal structure illustrated in FIG. 1 in the W-type hexagonal ferrite (structural formula: A²⁺ Me²⁺₂Fe₁₆O₂₇), barium (Ba) or strontium (Sr), which is a divalent cation having a relatively large ionic radius, or sodium (Na) or potassium (K), which is a monovalent cation having a relatively large ionic radius, are necessary.

In particular, when the Ba content is 5.1 mol % to 5.2 mol %, W-type hexagonal ferrite single phase can be synthesized as apparent from Nos. 4 to 6 and 13 to 15 in Table 2. Thus, as indicated in Nos. 4 to 6 and 13 to 15 in Table 1, the saturation magnetization is as high as saturation magnetization 270 [mT], and the coercivity is low, such as about 30 kA/m; thus, at 1 GHz, Q≥40 and permeability μ′≥1.8, which is high. Since the saturation magnetization is higher than Y-type ferrite, the issues associated with DC superposition are suppressed compared with other hexagonal soft magnetic ferrites. Since Q and the permeability at 1 GHz are high, an inductor formed of this composition has better characteristics than other ferrite materials at high frequencies such as 1 GHz, and an inductance L higher than that of an air core coil that includes a nonmagnetic body can be obtained.

Full substitution is possible between Ba and Sr. As indicated in FIG. 8 and Nos. 27 to 31 in Table 3 in Example 2-1, increasing Sr increases the saturation magnetization and can increase the permeability; however, the magnetic loss tends to be high and Q tends to be slightly low. As indicated in No. 31 in Table 3, when full substitution with Sr is conducted, the permeability μ′=about 2.26 and Q=38, which is high.

When the Ba content is large, as indicated in Nos. 19 to 21 in Table 2 in Example 1 and Fe content m=7 in FIG. 4, a different phase, i.e., Y-type ferrite phase, precipitates, and, as indicated in No. 19 in Table 1, the coercivity increases to coercivity≥50 kA/m, thereby decreasing Q at 1 GHz to Q≤20, decreasing the specific resistance, and increasing the dielectric constant.

When the total Ba+Sr content is small, as indicated in No. 26 in Table 2 in Example 1 and Fe content m=9 in FIG. 4, a different phase, i.e., spinel phase, precipitates, and, as indicated in No. 26 in Table 1 in Example 1, the coercivity increases to coercivity=101 kA/m, thereby decreasing μ and Q at 1 GHz to μ=1.21 and Q=4, decreasing the specific resistance, and increasing the dielectric constant.

The upper limit of the Ba content is set to 5.8 mol % in view of No. 21 in Table 1, and the upper limit of the Sr content is set to 5.8 mol % in view of No. 89 in Table 7.

The lower limit of the Ba content is set to 0 mol % in view of No. 31 in Table 3, and the lower limit of the Sr content is set to 0 mol % in view of No. 27 in Table 3.

The lower limit of the Ba+Sr content is set to 4.7 mol % in view of No. 25 in Table 1, and the upper limit of the Ba+Sr content is set to 5.8 mol % in view of No. 89 in Table 7.

All or some of Ba and Sr elements serving as the A site elements may be substituted with an alkali metal element (K, Na, or the like) having a relatively large ionic radius or La as indicated in Table 10 or 11. In such a case, the lower limit of Ba+Sr+Na+K+La is set to 4.7 mol % and the upper limit is set to 5.8 mol %.

<2> Essential element (Ca: 0.2 mol % to 5.0 mol %)

In order to synthesize W-type hexagonal ferrite (structural formula: A²⁺Me²⁺₂Fe₁₆O₂₇) single phase, it is effective to add calcium (Ca). In the present invention, the effect is obtained by firing the composition in air that does not generate Fe²⁺ different from firing in a reducing atmosphere where generation of Fe²⁺ is unavoidable.

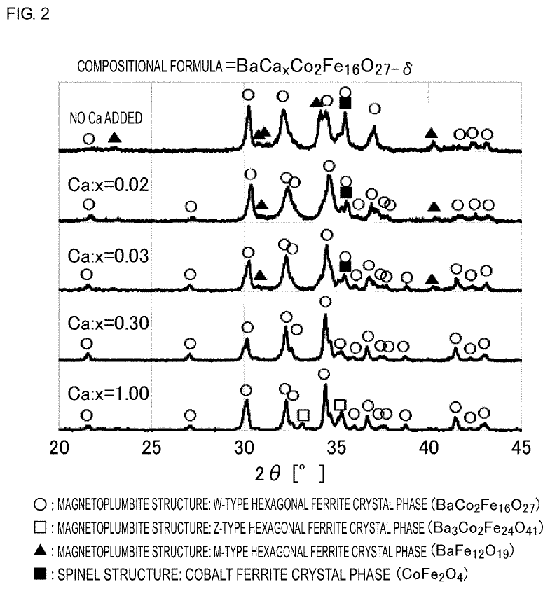

In particular, when the Ca content is 0.5 mol % to 2.6 mol %, a single phase of W-type hexagonal ferrite is synthesized as apparent from Nos. 4 to 6 in Table 2 and FIG. 2. Thus, as indicated in Nos. 4 to 6 in Table 1, the saturation magnetization is as high as saturation magnetization≥280 [mT], and the coercivity is as low as coercivity 35 kA/m; thus, at 1 GHz, Q≥40 and permeability μ′≥1.9, which is high. Since the saturation magnetization is high, the issues associated with DC superposition are suppressed compared to other hexagonal soft magnetic ferrites. Moreover, since the permeability and Q at 1 GHz are high, an inductor obtained from this composite offers better performance than other ferrite materials at high frequencies such as 1 GHz, and an inductance L higher than that of an air core coil can be obtained.

When the Ca content is large and the A site element is Ba, as apparent from Nos. 7 to 9 in Table 2 in Example 1 and Ca:x=1.00 in FIG. 2, a different phase, namely, Z-type ferrite, precipitates and inhibits synthesis of W-type ferrite single phase, and as apparent from No. 9 in Table 1 and FIG. 6, the permeability and Q of the magnetic body at 1 GHz decrease to permeability μ′=1.49 and Q=14.

When the Ca content is small and the A site element is Ba, as apparent from Nos. 1 to 3 in Table 2 in Example 1 and Ca:x=no Ca added, x=0.02, and x=0.03 in FIG. 2, different phases, namely, M-type ferrite and spinel, precipitate and inhibit synthesis of W-type ferrite single phase. As a result, when the A site element is Ba, as apparent from Nos. 1 and 2 in Table 1 and FIG. 6, coercivity≥30 kA/m, and Q at 1 GHz decreases to Q≤19.

The upper limit of the Ca content is set to 5.0 mol % in view of No. 8 in Table 1. The lower limit of the Ca content is set to 0.2 mol % in view of No. 3 in Table 1.

<3> Essential element (Fe: 72.5 mol % to 86.0 mol %)

In order to form W-type hexagonal ferrite (structural formula A²⁺Me²⁺₂Fe₁₆O₂₇) and yield ferromagnetism, iron (Fe) is necessary.

When only the essential elements, Ba, Ca, Co, and Fe, are used, as apparent from Nos. 22 to 24 in Table 2 and Fe content m=8 in FIG. 4, W-type hexagonal ferrite is the most abundant phase at an Fe content of 82.0 mol % to 83.7 mol %. Thus, as indicated in Nos. 22 to 24 in Table 1, the saturation magnetization is as high as saturation magnetization≥270 [mT], and the coercivity is as low as about 30 kA/m; thus, at 1 GHz, Q≥40 and permeability μ′≥1.9, which is high. Since the saturation magnetization is high, the issues associated with DC superposition are suppressed compared to other hexagonal soft magnetic ferrites. Moreover, since the permeability and Q at 1 GHz are high, at high frequencies such as about 1 GHz, this material has better functions as an inductor than other ferrite materials, and an inductance L higher than that of an air core coil can be obtained.

Examples of Fe-site substitution are Co—(Ge, Hf, Si, Sn, Ti, Zr) composite substitution indicated in Table 5, Al, Ga, In, or Sc single substitution indicated in Table 6, and Ni—(Mo, Nb, Sb, Ta, W, V) composite substitution indicated in Table 8.

As indicated in Tables 9 and 10, some of the Fe site elements may be substituted with Li. The optimum Fe content is considered to decrease due to the Fe-site element substitution.

When the Fe content is large, as indicated in Nos. 25 to 26 in Table 2 in Example 1 and Fe content m=9 in FIG. 4, spinel phase precipitates, and, as indicated in No. 26 in Table 1, the coercivity increases to 101 kA/m, thereby decreasing Q and the permeability μ′ at 1 GHz to Q=4 and permeability μ′=1.21

When the Fe content is small, as indicated in Nos. 19 to 21 in Table 2 in Example 1 and Fe content m=7 in FIG. 4, Y-type ferrite phase precipitates, and, in view of No. 19 in Table 1, the coercivity increases to 150 kA/m, thereby decreasing Q and permeability μ at 1 GHz to Q=6 and permeability μ′=1.11.

The upper limit of the Fe content is set to 86.0 mol % in view of No. 11 in Table 1 in Example 1.

The lower limit of the Fe content is set to 72.5 mol % since this is the lowest in view of Nos. 57 and 65 in Table 5. The lower limits of the respective examples are 78.8 mol % for No. 17 in Table 1 in Example 1, 72.5 mol % for Nos. 57 and 65 in Table 5 in Example 2-3, and 75.1 mol % for Nos. 80 and 85 in Table 6 in Example 2-4.

Note that in 2d sites of W-type hexagonal ferrite illustrated in FIG. 1, Fe-ions are 5-coordinated, and since the oxygen position in the c-axis direction is farther than that in the c-plane direction, W-type hexagonal ferrite has c-axis anisotropy and generally tends to exhibit hard magnetism.

<4> Essential element (Co: 7.0 mol % to 15.5 mol %)

Since W-type hexagonal ferrite (structural formula: A²⁺Me²⁺₂Fe₁₆O₂₇) typically has c-axis anisotropy (the direction of spins tends to be along the c-axis) due to the influence of Fe ions occupying the 5-coordinated sites (the 2d sites in FIG. 1), W-type hexagonal ferrite is known to exhibit hard magnetism suitable as a magnet material. In order for W-type hexagonal ferrite to exhibit soft magnesium, cobalt (Co) is considered necessary at 6-coordinated sites so that spins are easily directed toward the c-plane direction of hexagonal ferrite.

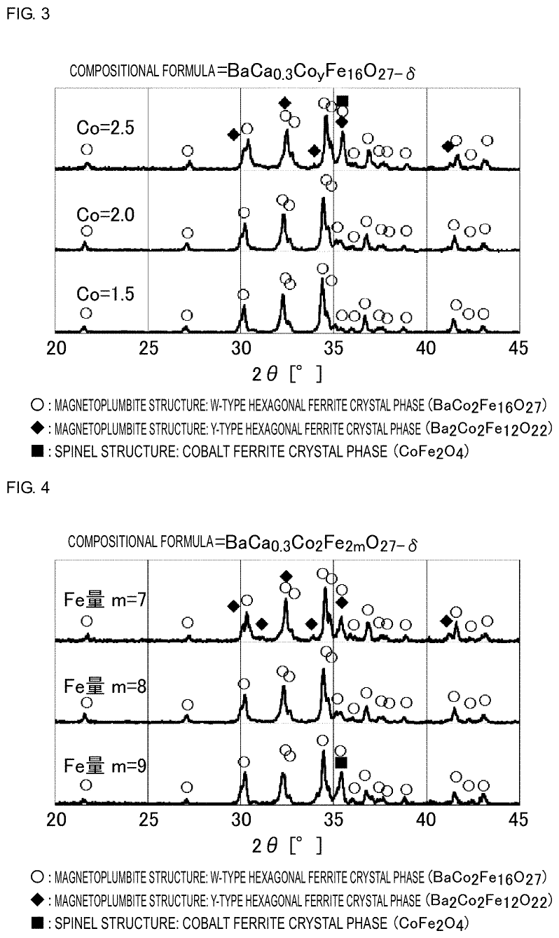

When only the essential elements, Ba, Ca, Co, and Fe, are used, as apparent from Nos. 13 to 15 in Table 2 and Co=2.0 in FIG. 3, W-type hexagonal ferrite single phase is synthesized when the Co content is 9.4 mol % to 11.3 mol %. Thus, as indicated in Nos. 13 to 15 in Table 1, the saturation magnetization is as high as saturation magnetization≥270 mT, and the coercivity is as low as about 30 kA/m; thus, at 1 GHz, Q≥40 and permeability μ′≥1.9, which is high. Since the saturation magnetization is high, the issues associated with DC superposition are suppressed compared to other hexagonal soft magnetic ferrites. Moreover, since the permeability and Q at 1 GHz are high, at high frequencies such as about 1 GHz, this material has better functions as an inductor than other ferrite materials, and an inductance L higher than that of an air core coil can be obtained.

When the Co content is large, as indicated in Nos. 16 to 18 in Table 2 in Example 1 and Co=2.5 in FIG. 3, different phases, such as Y-type phase and spinel phase precipitate, and, as indicated in No. 18 in Table 1, the coercivity increases to 41 kA/m, thereby decreasing Q and the permeability μ′ at 1 GHz to Q=14 and permeability μ′=1.49

When the Co content is small, as indicated in No. 10 in Table 2 in Example 1 and Co=1.5 in FIG. 3, no different phase could be observed; however, as indicated in No. 10 in Table 1, the saturation magnetization decreased to 249 mT, the magnetic loss at 1 GHz decreased to 1.49, the specific resistance decreased, and the dielectric constant increased.

The upper limit of the Co content is set to 15.5 mol % in view of Nos. 57 and 65 in Table 5 in Example 2-3. The upper limits of the respective examples are 14.8 mol % as indicated in No. 17 in Example 1 and 15.5 mol % as indicated in Nos. 57 and 65 in Example 2-3.

The lower limit of the Co content is set to 7.0 mol % in view of No. 11 in Table 1 in Example 1.

<5> Balance between multiple elements (D: 7.0 Mol % to 14.8 mol % when definitions are as follows: Me(I)=Li+Na+K, Me(II)=Co+Cu+Mg+Mn+Ni+Zn, Me(IV)=Ge+Si+Sn+Ti+Zr+Hf, Me(V)=Mo+Nb+Ta+Sb+W+V, D=Me (I)+Me (II)−Me (IV)−2×Me (V))

Me(I) is defined as an element that has a tendency to form a monovalent cation, Me(II) is defined as an element that has a tendency to form a divalent cation, Me(IV) is defined as an element that has a tendency to form a tetravalent cation, and Me(V) is defined as an element that has a tendency to form a pentavalent or higher-valent cation. Keeping the charge balance increases the specific resistance, decreases the magnetic loss at 1 GHz, and decreases the dielectric constant. However, since the charge amount is difficult to measure from polycrystal insulators, that the charge balance is achieved is assumed from the fact that the specific resistance is high. D is varied in Table 1. In particular, at D=9.4 mol % to 11.3 mol %, Nos. 13 to 15 and 22 to 24 in Table 1 indicate that the permeability μ′ and Q are relatively high values, i.e., μ′≥1.9 and Q≥40. D is fixed at D=10.4 mol % in Tables 3 to 6.

The lowest value of D is 7.0 mol % as indicated in No. 11 in Table 1, and the highest value of D is 14.8 mol % as indicated in No. 17 in Table 1. When the value of D is outside the range, the magnetic loss at 1 GHz increases, and the dielectric constant increases.

<6> Cu: 0 mol % to 2.6 mol %, Mg: 0 mol % to 2.6 mol %, Mn: 0 mol % to 2.6 mol %, Ni: 0 mol % to 5.2 mol %, Zn: 0 mol % to 2.6 mol %

As indicated in Nos. 32 to 35 in Table 4 in Example 2-2, partial substitution with Cu monotonically decreases the permeability μ′ and Q at 1 GHz, and monotonically increases the magnetic loss μ″. No. 35 in Table 4 indicates that, at Cu=5.2 mol %, μ=1.49, and Q=5, and thus both μ′ and Q are outside the range.

The upper limit of the Cu content is set to 2.6 mol % in view of No. 34 in Table 4 in Example 2-2.

As indicated in Nos. 32 and 36 to 38 in Table 4 in Example 2-2, partial substitution with Mg monotonically decreases the permeabilityμ′ and Q at 1 GHz, and monotonically increases the magnetic loss μ″. No. 38 in Table 4 indicates that, at Mg=5.2 mol %, permeability μ′=1.51, and Q=5, and thus both μ′ and Q are outside the range.

The upper limit of the Mg content is set to 2.6 mol % in view of No. 37 in Table 4 in Example 2-2.

As indicated in Nos. 32 and 39 to 41 in Table 4 in Example 2-2, partial substitution with Mn decreases the dielectric constant, but monotonically decreases the permeabilityμ′ and Q at 1 GHz and monotonically increases the magnetic loss μ″. No. 41 in Table 4 indicates that, at Mn=5.2 mol %, permeability μ′=1.40, and Q=7, and thus both μ′ and Q are outside the range.

The upper limit of the Mn content is set to 2.6 mol % in view of No. 40 in Table 4 in Example 2-2.

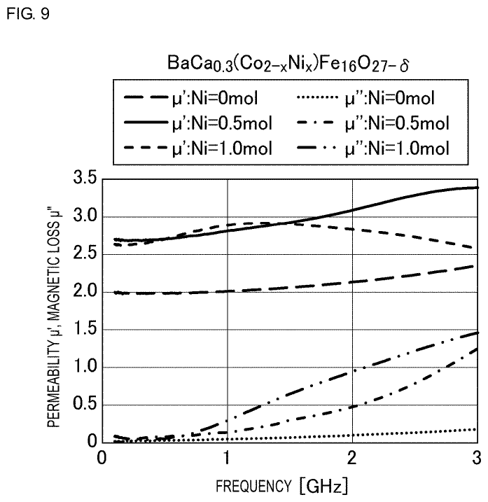

As indicated in Nos. 32 and 42 to 44 in Table 4 in Example 2-2 and FIG. 9, partial substitution with Ni monotonically increases the permeability μ′ and the magnetic loss μ″ at 1 GHz, and monotonically decreases Q. No. 44 in Table 4 indicates that, at Ni=5.2 mol %, permeability μ′=2.89, and Q=9, and thus Q is outside the range.

However, as indicated in Nos. 94 to 109 in Table 8 in Example 2-6 in which composite substitution with Ni and Mo or the like is performed, the magnetic loss μ″ at 1 GHz monotonically increases, Q monotonically decreases, and the permeability μ′ increases until Ni substitution amount 5.2 mol %. Nos. 97, 100, 103, and 106 in Table 8 indicate that, at Ni=10.4 mol %, Q=16, and thus Q is outside the range.

The upper limit of the Ni content is set to 5.2 mol % in view of Nos. 96, 99, 102, 105, and 108 in Table 8 in Example 2-6.

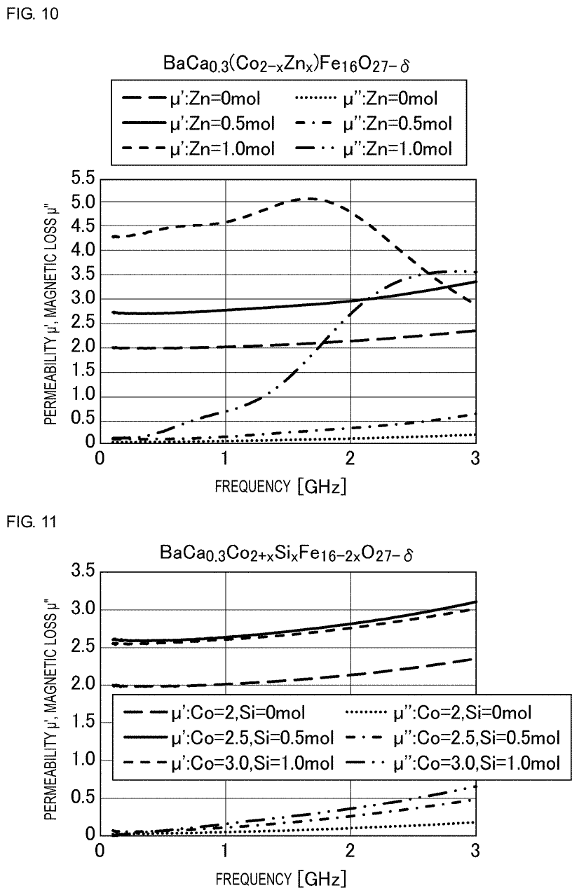

As indicated in Nos. 32 and 45 to 47 in Table 4 in Example 2-2 and FIG. 10, partial substitution with Zn monotonically increases the permeability μ′ and the magnetic loss μ″ at 1 GHz, and monotonically decreases Q. No. 47 in Table 4 indicates that, at Zn=5.2 mol %, permeability μ′=4.63, and Q=7, and thus Q is outside the range.

The upper limit of the Zn content is set to 2.6 mol % in view of No. 46 in Table 4 in Example 2-2.

<7> Ge: 0 mol % to 2.6 mol %, Si: 0 mol % to 2.6 mol %, Ti: 0 mol % to 2.6 mol %

Partial substitution with Ge, Si, and Ti, which tend to form tetravalent cations, can correct the charge imbalance acquired by partial substitution of Fe sites with Co and the like that tend to form divalent cations.

As indicated in Nos. 48 to 51 in Table 5 in Example 2-3, partial substitution with Ge monotonically increases the magnetic loss μ″ at 1 GHz and monotonically decreases the permeability μ′ and Q. No. 51 in Table 5 indicates that, at Ge=5.2 mol %, permeability μ′=1.27, and Q=5, and thus the permeability μ′ and Q are outside the range.

The upper limit of the Ge content is set to 2.6 mol % in view of No. 50 in Table 5 in Example 2-3.

As indicated in Nos. 48 and 52 to 54 in Table 5 in Example 2-3 and FIG. 11, partial substitution with Si monotonically increases the magnetic loss μ″ at 1 GHz, monotonically decreases Q, and increases the permeability μ′ until Si content 2.6 mol %. No. 54 in Table 5 indicates that, at Si=5.2 mol %, permeability μ′=2.61, and Q=16, and thus Q is outside the range.

The upper limit of the Si content is set to 2.6 mol % in view of No. 53 in Table 5 in Example 2-3.

As indicated in Nos. 48 and 60 to 62 in Table 5 in Example 2-3, partial substitution with Ti monotonically increases the magnetic loss μ″ at 1 GHz and monotonically decreases the permeability μ′ and Q. No. 62 in Table 5 indicates that, at Ti=5.2 mol %, permeability μ′=1.29, and Q=5, and thus the permeability μ′ and Q are outside the range.

The upper limit of the Ti content is set to 2.6 mol % in view of No. 61 in Table 5 in Example 2-3.

<8> Sn: 0 mol % to 5.2 mol %, Zr+Hf: 0 mol % to 5.2 mol %

Sn, Zr, and Hf substitute 5-coordinated sites of Fe, can correct the charge imbalance caused by partial substitution with Zn, Mn, and Ni, and can mitigate the effect of hard magnetism of 5-coordinated Fe with which the spins tend to direct in the c-axis direction of hexagonal ferrite.

As a result, Fe can be substituted with a larger amount of Co than when Si and Ti are used.

Note that Zr and Hf are the elements produced from the same mineral ore and have the same effect. Since isolation and purification raise cost, these elements are described as Zr+Hf.

As indicated in Nos. 48 and 55 to 59 in Table 5 in Example 2-3, partial substitution with Sn monotonically increases the magnetic loss μ″ at 1 GHz and monotonically decreases the permeability μ′ and Q. No. 58 in Table 5 indicates that, at Sn=7.8 mol %, permeability μ′=1.57, and Q=10, and thus Q is outside the range.

The upper limit of the Sn content is set to 5.2 mol % in view of No. 57 in Table 5 in Example 2-3.

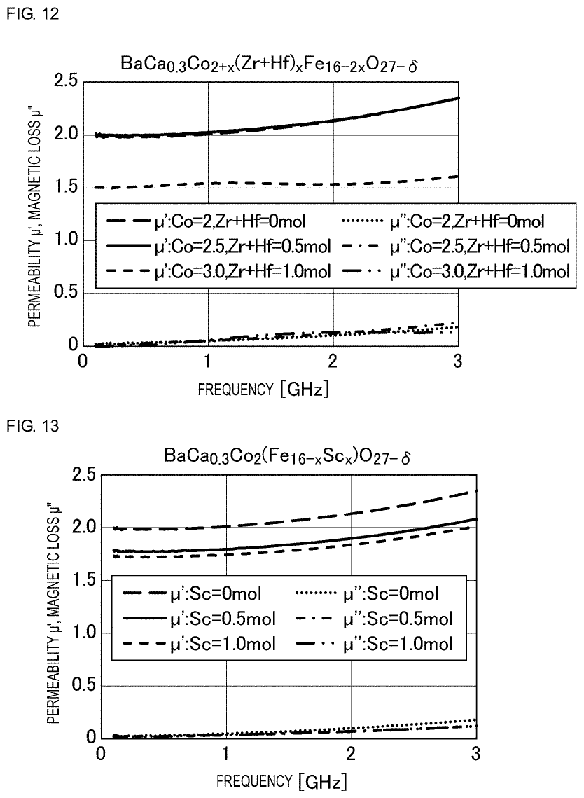

As indicated in Nos. 48 and 63 to 67 in Table 5 in Example 2-3 and FIG. 12, partial substitution with Zr+Hf monotonically increases the magnetic loss μ″ at 1 GHz, decreases the permeability μ′ after a slight increase, and monotonically decreases Q. No. 66 in Table 5 indicates that, at Zr+Hf=7.8 mol %, permeability μ′=1.49, and Q=12, and thus the permeability μ′ and Q are outside the range.

The upper limit of the Zr+Hf content is set to 5.2 mol % in view of No. 65 in Table 5 in Example 2-3.

<9> Al: 0 mol % to 5.2 mol %, Ga: 0 mol % to 5.2 mol %

When Al and Ga are partly substituted, Al and Ga substitute the 6-coordinated sites of Fe. Thus, the saturation magnetization decreases, the coercivity increases, the permeability μ′ and Q monotonically decrease, and the magnetic loss μ″ monotonically increases as indicated in Nos. 68 to 72 in Table 6 in Example 2-4 in the case of Al and as indicated in Nos. 68 and 73 to 76 in Table 6 in the case of Ga.

The upper limit of the Al content is set to 5.2 mol % in view of No. 71 in Table 6. The upper limit of the Ga content is set to 5.2 mol % in view of No. 75 in Table 6.

<10> In: 0 mol % to 7.8 mol %, Sc: 0 mol % to 7.8 mol %

When In and Sc are partly substituted, In and Sc substitute the 5-coordinated sites of Fe. Thus, the saturation magnetization decreases, the permeability μ′ monotonically decreases, the magnetic loss μ″ increases after a slight decrease, and thus Q decreases after a slight increase as indicated in Nos. 68 and 77 to 81 in Table 6 in Example 2-4 in the case of In and as indicated in Nos. 68 and 82 to 86 in Table 6 and FIG. 13 in the case of Sc.

The upper limit of the In content is set to 7.8 mol % in view of No. 80 in Table 6 in Example 2-4. The upper limit of the Sc content is set to 7.8 mol % in view of No. 85 in Table 6.

<11> Mo: 0 mol % to 2.6 mol %, Nb+Ta: 0 mol % to 2.6 mol %, Sb: 0 mol % to 2.6 mol %, W: 0 mol % to 2.6 mol %, V: 0 mol % to 2.6 mol %

Partial substitution with Mo, Nb, Ta, Sb, W, and V can correct the charge imbalance caused by partial substitution of Ni at Fe sites, and an effect can be achieved with a smaller amount compared to the case where Ge, Si, Ti, etc., are used. As a result, as indicated in Nos. 94 to 96, 98, 99, 101, 102, 104, 105, 107, and 108 in Table 8, the permeability μ′ and Q can be adjusted to permeability μ′≥1.5 and Q≥20 at 1 GHz. Further increasing the substitution amount decreases Q to Q<20 as indicated in Nos. 97, 100, 103, 106, and 109 in Table 8.

The upper limit of the Mo content is set to 2.6 mol % in view of No. 96 in Table 8. The upper limit of the Nb+Ta content is set to 2.6 mol % in view of No. 99 in Table 8. The upper limit of the Sb content is set to 2.6 mol % in view of No. 102 in Table 8. The upper limit of the W content is set to 2.6 mol % in view of No. 105 in Table 8. The upper limit of the V content is set to 2.6 mol % in view of No. 108 in Table 8.

Note that Nb and Ta are the elements often produced from the same mineral ore and are chemically similar to each other. Since isolation and purification raise cost, these elements are described as Nb+Ta.

The soft magnetic composition of the present invention has a coercivity Hcj of 40 kA/m or less.

Since decreasing the coercivity can increase the permeability, the coil inductance L can be increased. In contrast, when the coercivity is high as with magnet materials, it is difficult to obtain the desired high permeability.

At coercivity Hcj>40 kA/m, the permeability μ′ decreases to permeability μ′<1.50, and sufficient superiority is lost as an inductor compared with air core coils.

The soft magnetic composition of the present invention preferably has a coercivity Hcj of 30 kA/m or less. A soft magnetic composition that has a coercivity Hcj of 30 kA/m or less is preferably an oxide that has the following metal element ratios:

Ba: 5.1 mol % to 5.2 mol %,

Ca: 0.5 mol % to 2.6 mol %,

Fe: 82.0 mol % to 83.7 mol %, and

Co: 9.4 mol % to 11.3 mol %.

The soft magnetic composition of the present invention preferably has a saturation magnetization Is of 200 mT or more.

It is known that when the residual magnetic flux density Bs is increased by increasing the saturation magnetization Is, the DC superposition characteristics at high current are improved. The trends toward low voltage and high current are also present in signal-system circuits. Thus, when the saturation magnetization Is is less than 200 mT, the risk of DC superposition rises even in high-permeability materials such as Y-type ferrite. Thus, the saturation magnetization is preferably at least saturation magnetization Is ≥200 mT.

In the soft magnetic composition of the present invention, the maximum major axis diameter of crystal grains is preferably less than 3 μm and the average crystal grain diameter is preferably 0.05 μm to 2 μm.

Furthermore, the maximum major axis diameters of primary particles and the crystal grains are preferably less than 3 μm and the average crystal grain diameter is preferably 0.05 μm to 2 μm. More preferably, the average crystal grain diameter is 0.1 μm to 1 μm. These diameters refer to the diameters of the soft magnetic grains obtained by the process described in Examples, and do not include diameters of the fibers and the like that are added after calcining.

It is known that the range of the magnetic single domain grain diameter of hexagonal ferrite is about 0.1 μm to about 1.0 μm. At a magnetic single domain grain diameter, the loss caused by magnetic domain wall resonance can be suppressed, and this contributes to increasing Q. At a grain diameter less than 0.1 μm, superparamagnetic characteristics are exhibited, and the permeability μ′ decreases to permeability μ′=1.

The average crystal grain diameter is preferably 0.05 μm or more and more preferably 0.1 μm or more. As long as the average crystal grain diameter is 0.1 μm or more, the permeability can be adjusted to permeability μ′ 1.5.

In particular, the maximum major axis diameter of the crystal grains is preferably less than 3 μm and the average crystal grain diameter is preferably 2 μm or less, and the average crystal grain diameter is more preferably 1 μm or less. Furthermore, the maximum major axis diameters of primary particles and the crystal grains are preferably less than 3 μm and the average crystal grain diameter is preferably 2 μm or more and more preferably 1 μm or less. As long as the average crystal grain diameter is 1 μm or less, Q can be increased due to the magnetic single domain grain diameter.

The crystal grains refer to ceramic grains as defined in JIS R 1670. The crystal grain diameter is determined by calculating the equivalent circle diameter specified in JIS R 1670 and calculating the average therefrom. The maximum major axis diameter of the crystal grains is calculated by observing a ceramic surface with an optical microscope in a 0.2 mm square view area, measuring the major diameter described in JIS R 1670, and determining the maximum value.

The maximum major axis diameter of the primary particles is determined by measuring the major diameter of the powder by an imaging method and determining the maximum value. Specifically, images of particles of the powder are acquired through an electron microscope (SEM), and individual particles are extracted from an assembly of primary particles captured in the image and assumed to be primary particles. The major diameter of each of the particles is measured, and the maximum value is defined as the maximum major axis diameter of the primary particles.

The soft magnetic composition of the present invention preferably has a specific resistance ρ of 10⁶ Ω·m or more.

When the specific resistance is low, the eddy-current loss increases at low frequencies; thus, the magnetic loss and the dielectric constant are high even at 1 GHz. As long as the specific resistance ρ is as high as specific resistance ρ≥10⁶ [Ω·m], the eddy-current loss decreases even in the GHz band, and Q 20 can be easily achieved at 1 GHz.

The soft magnetic composition of the present invention preferably has a permeability μ′ of 1.5 or more.

When the permeability is high, such as permeability μ′≥1.5, the inductance of a coil illustrated in FIG. 15 prepared from such a composition can be increased.

In the soft magnetic composition of the present invention, Q of the magnetic body is preferably 20 or more.

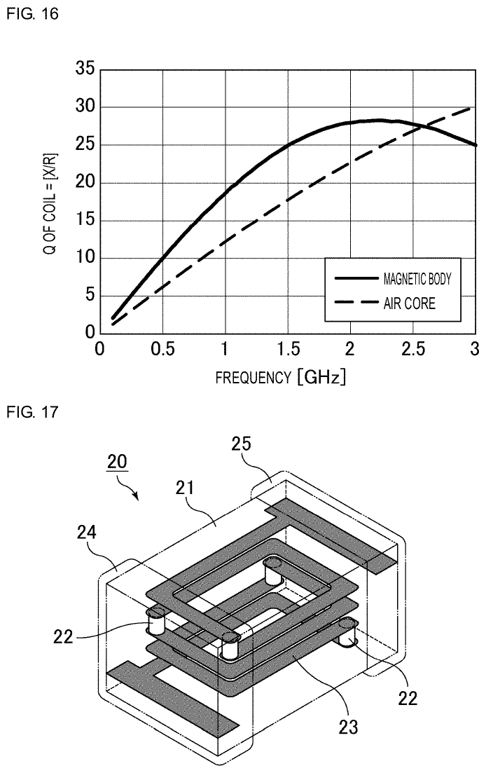

Since Q of the magnetic body is high, the magnetic loss can be reduced, and thus the decrease in Q of the coil caused by insertion of the magnetic core can be suppressed. When the composition is formed into a magnetic body and worked into a coil illustrated in FIG. 16, Q of the coil can be increased.

The soft magnetic composition of the present invention preferably has a dielectric constant c of 100 or less.

When the stray capacitance of the coil is large and when the LC resonant frequency inside the coil component decreases to several GHz or less, the function of an inductor is lost even if Q of the magnetic material is high. Thus, in order for the composition to be useful for GHz-band inductors, the dielectric constant c of the material is preferably at least controlled to dielectric constant C 100.

The soft magnetic composition of the present invention is in a powder state. In order to make such a soft magnetic composition industrially useful, the soft magnetic composition needs to be in a liquid or solid state. For example, a sintered body is preferable for use as a winding inductor. For use as a laminated inductor, a sintered body may be used, but it is effective to add a nonmagnetic body such as glass or resin in order to decrease the stray capacitance by decreasing the dielectric constant and to be compatible with higher frequencies. A paste form is preferable for use as a magnetic fluid.

A sintered body obtained by firing the soft magnetic composition of the present invention or a composite body or paste obtained by mixing the soft magnetic composition of the present invention and a nonmagnetic body formed of at least one selected from glass and a resin are also encompassed by the present invention. The sintered body, composite body, or paste of the present invention may contain a ferromagnetic body or another soft magnetic body.

The sintered body refers to a fine ceramic as defined in JIS R 1600. The composite body refers to a material produced by interfacially and firmly bonding, uniting, or combining two or more materials with different properties while the respective materials maintain the respective phases. The paste refers to a high-flowability, high-viscosity substance of a dispersion system in which a soft magnetic powder is suspended.

The nonmagnetic body refers to a substance that is not ferromagnetic and that has a saturation magnetization of 1 mT or less.

Furthermore, a coil component formed by using the sintered body, composite body, or paste of the present invention is also encompassed by the present invention. The coil component of the present invention can also be used as a noise filter that utilizes the LC resonance when combined with a capacitor.

The coil component refers to an electronic component that uses a coil described in JIS C 5602.

The coil component of the present invention is equipped with a core portion and a winding portion disposed around the core portion, in which the core portion is formed by using the sintered body, composite body, or paste of the present invention, and the winding portion always contains an electrical conductor such as silver or copper.

The winding refers to a wire that connects the periphery of or a part of the inside of a substance having spontaneous magnetization with an electrical conductor. The electrical conductor refers to a structure that is composed of a material having an electrical conductivity a of 10⁵ S/m or more, in which two ends of the winding are electrically connected.

Furthermore, an antenna formed by using the sintered body, composite body, or paste of the present invention is also encompassed by the present invention.

### EXAMPLES

Examples that more specifically disclose the present invention will now be described. Note that the present invention is not limited only by these examples.

### Example 1

In W-type hexagonal ferrite (stoichiometric composition: BaCo₂Fe₁₆O₂₇), calcium (Ca) can penetrate into all of Ba, Fe, and grain boundaries; thus, the compositional formula is described in the form of BaCaₓCo_{y}Fe₂ₘO_{27-δ}. Powder raw materials of barium carbonate, calcium carbonate, iron oxide, and cobalt oxide were blended so that the Ba, Ca, Co, and Fe metal ion ratios of the compositional formula BaCaₓCo_{y}Fe₂ₘO_{27-δ} were the ratios specified in Table 1 and that the total of the raw materials was 100 g. Into a 500 cc polyester pot, 80 to 120 g of pure water, 1 to 2 g of an ammonia polycarboxylate dispersant and 1 kg of PSZ media having a diameter of 1 to 5 mmϕ were placed. The resulting mixture was mixed in a ball mill for 8 to 24 hours at a rotation rate of 100 to 200 rpm and evaporated to be dried to obtain a dry powder mixture.

The dry powder mixture was passed through a sieve having an aperture of 20 to 200 μm to obtain a sized powder. The sized powder was calcined at 1100 to 1300° C. in air, and, as a result, a calcined powder having a W-type hexagonal ferrite crystal structure illustrated in FIG. 1 could be synthesized. The crystal phase and the degree of synthesis of the composition are indicated in Table 2.

As a representative example, XRD peak intensity ratios obtained by analyzing calcined powders having the composition BaCaₓCo_{y}Fe₂ₘO_{27-δ} by varying Ca content x=0.00 to 1.00, Co content y=1.5 to 2.5, and Fe content m=7 to 9 with an X-ray diffractometer (XRD) are illustrated in FIGS. 2, 3, and 4.

FIG. 2 illustrates XRD peak intensity ratios of calcined powders having a compositional formula: BaCaₓCo₂Fe₁₆O_{27-δ} with varied Ca contents x. In FIG. 2, No Ca added indicates No. 1 in Table 1, Ca:x=0.02 indicates No. 2 in Table 1, Ca:x=0.03 indicates No. 3 in Table 1, Ca:x=0.30 indicates No. 5 in Table 1, and Ca:x=1.00 indicates No. 8 in Table 1.

FIG. 2 indicates that when Ca was not added, different phases, such as M-type ferrite phase (BaFe₁₂O₁₉) and cobalt ferrite phase (CoFe₂O₄) that exhibit magnet properties, precipitated in addition to W-type ferrite phase (BaCo₂Fe₁₆O₂₇). Addition of Ca at Ca content x=0.30 mol caused the different phases to disappear, and substantially single phase of W-type ferrite was formed. When Ca was added at Ca content x=1.00 mol, Z-type ferrite phase (Ba₃Co₂Fe₂₄O₄₁) precipitated.

FIG. 3 illustrates XRD peak intensity ratios of calcined powders having a compositional formula: BaCa_{0.3}Co_{y}Fe₁₆O_{27-δ} with varied Co contents y. In FIG. 3, Co=1.5 indicates No. 12 in Table 1, Co=2.0 indicates No. 14 in Table 1, and Co=2.5 indicates No. 16 in Table 1.

FIG. 3 indicates that when Co content y=1.5 to 2.0 mol, substantially single phase of W-type ferrite phase (BaCo₂Fe₁₆O₂₇) was formed, and at Co content y=2.5 mol, different phases such as Y-type ferrite phase (Ba₂Co₂Fe₁₂O₂₂) and cobalt ferrite phase (CoFe₂O₄) precipitated.

FIG. 4 illustrates XRD peak intensity ratios of calcined powders having a compositional formula: BaCa_{0.3}Co₂Fe₂ₘO_{27-δ} with varied Fe contents 2m. In FIG. 4, Fe content m=7 indicates No. 21 in Table 1, Fe content m=8 indicates No. 23 in Table 1, and Fe content m=9 indicates No. 25 in Table 1.

FIG. 4 indicates that at Fe content m=8, W-type ferrite phase (BaCo₂Fe₁₆O₂₇) formed substantially single phase, but at Fe content m=7, a different phase, i.e., Y-ferrite phase (Ba₂Co₂Fe₁₂O₂₂), precipitated, an at Fe content m=9, a different phase, i.e., cobalt ferrite phase (CoFe₂O₄), precipitated.

Into a 500 cc polyester pot, 80 g of the calcined powder described above, 60 to 100 g of pure water, 1 to 2 g of an ammonium polycarboxylate dispersant, and 1000 g of PSZ media having a diameter of 1 to 5 mmϕ were placed, and the resulting mixture was ground for 70 to 100 hours in a ball mill at a rotation rate of 100 to 200 rpm to obtain fine particle slurry. To the fine particle slurry, 5 to 15 g of a vinyl acetate binder having a molecular weight of 5000 to 30000 was added, and the resulting mixture was formed into sheets by a doctor blade method using a polyethylene terephthalate sheet material, at blade-to-sheet distance: 100 to 250 μm, drying temperature: 40 to 60° C., and sheet take-up speed: 5 to 50 cm/minute. This sheet was blanked into 5.0 cm square pieces, ferrite sheets each prepared by separating the polyethylene terephthalate sheet from the blanked pieces were stacked on top of each other so that the total sheet thickness was 0.3 to 2.0 mm and were placed in a stainless steel die, and a pressure of 150 to 300 MPa was applied from above and under the die while the die was being heated to 50 to 80° C. so as to pressure-bond the ferrite sheets. As a result, a pressure-bonded body was obtained. The pressure-bonded body was blanked while being heated to 60 to 80° C. such that, for the permeability measurement, the pressure-bonded body after sintering would have a ring shape having an outer diameter of 7.2 mmϕ, an inner diameter of 3.6 mmϕ, and a thickness of 1 mm, and, for the specific resistance, density, and magnetic curve measurement, the pressure-bonded body was blanked into a round plate having a diameter of 10 mmϕ to thereby obtain workpieces.

The workpieces having a round plate shape and a ring shape were placed on a zirconia setter and heated in air at a temperature elevation rate of 0.1 to 0.5° C./minute at a maximum temperature of 400° C. by holding the maximum temperature for 1 to 2 hours so as to thermally decompose and degrease the binder and the like, and then fired at a firing temperature selected from 900 to 1100° C. at which the magnetic loss μ″ at 1 GHz is minimum and at a temperature elevation rate of 1 to 5° C./minute and a maximum temperature retaining time of 1 to 5 hours so as to obtained a sintered body.

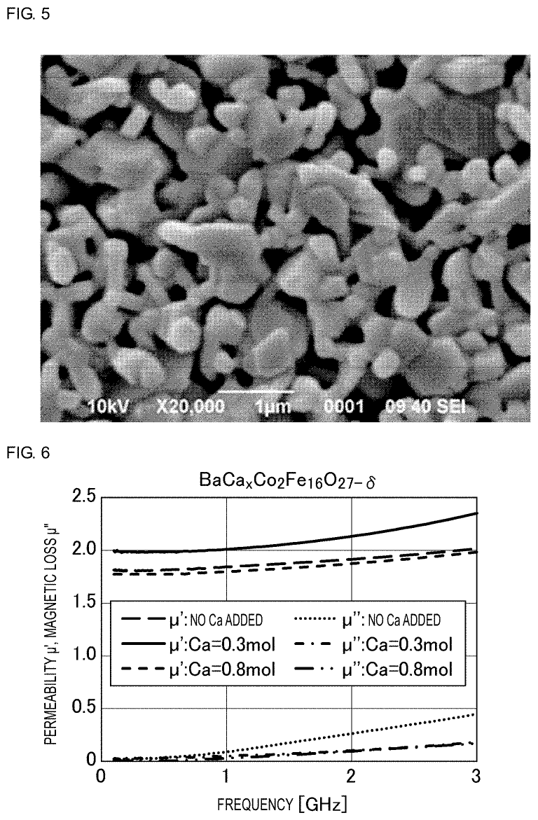

The surface SEM image of a sintered body having a compositional formula BaCa_{0.3}Co₂Fe₁₆O₂₇ (No. 5 in Table 1) is illustrated in FIG. 5. FIG. 5 indicates an assembly of hexagonal plate grains and that there remain a large number of voids. Due to these voids, the magnetic loss can be decreased, and high Q is achieved. The maximum major axis diameter of the hexagonal plate grains is less than 3 μm.

The influence of the Ca content on the frequency characteristics of permeability for compositional formula BaCaₓCo₂Fe₁₆O_{27-δ} is illustrated in FIG. 6. In FIG. 6, No Ca added indicates No. 1 in Table 1, Ca=0.3 mol indicates No. 5 in Table 1, and Ca=0.8 mol indicates No. 7 in Table 1.

FIG. 6 indicates that a composition with Ca content x=0.3 can achieve an increased permeability μ′.

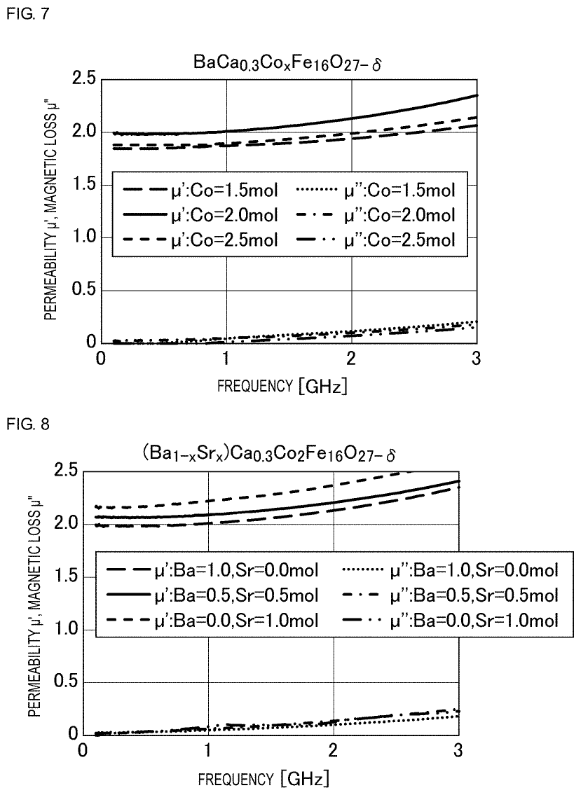

The influence of the Co content on the frequency characteristics of permeability of the composition for compositional formula BaCa_{0.3}CoxFe₁₆O_{27-δ} is illustrated in FIG. 7. In FIG. 7, Co=1.5 mol indicates No. 12 in Table 1, Co=2.0 mol indicates No. 14 in Table 1, and Co=2.5 mol indicates No. 16 in Table 1.

FIG. 7 indicates that the permeability μ′ at Co=2.0 mol, which is the stoichiometric composition of W-type ferrite, is the highest.

The permeability was measured with an impedance analyzer produced by Keysight Technologies by using 16454A-s fixture (ring maximum shape: outer diameter≤8.0 mm, inner diameter≥3.1 mm, thickness≤3.0 mm) to avoid dimensional resonance at frequencies within 3 GHz.

The saturation magnetization (Is) and the coercivity (Hcj=magnetic field at M=0 in the MH curve) determined by the magnetization curve were measured with a vibrating sample magnetometer (VSM) at a maximum magnetic field of 10 kOe. In order to calculate the saturation magnetization, the sinter density was separately measured in accordance with JIS R 1634 by an Archimedes' method. The saturation magnetization Is and the coercivity Hcj are easy to calculate since demagnetization correction due to the sample shape is not necessary.

The degree of crystal phase synthesis was measured by embedding a powder, which was prepared by crushing the calcined powder in a mortar, in a holder of an XRD analyzer produced by RIGAKU and measuring the XRD peak intensity ratios (%) therefrom.

The specific resistance was measured with an insulation-resistance meter by forming InGa alloy electrodes on both flat surface portions of a 10 mmϕ round plate.

The dielectric constant was measured with an impedance analyzer produced by Keysight Technologies by inserting a 20 mmϕ flat and smooth single plate into a 16453A fixture and measuring the dielectric constant at 1 GHz.

The permeability, magnetic loss, Q, saturation magnetization, coercivity, specific resistance, and dielectric constant observed when the Ca content, the Co content, and Fe content were varied in the composition are indicated in Table 1, and the crystal phase and the degree of synthesis are indicated in Table 2.

TABLE 1
Compositional formula: BaCaₓCo_{y}Fe₂ₘO_{27-δ}

| | | | | | | | | | Composite | | | Permeability at | | | Magnetization curve | | | |
|---|---|---|---|---|---|---|---|---|---|---|---|---|---|---|---|---|---|---|
| | | Compositional formula | | | | | | | composition | | | 1 GHz μ = | | | Saturation | Coer- | | |
| | | [mol] | | | Compositional ratio | | | | amount [mol %] | | | μ′ − jμ″ | | | magneti- | civity | Specific | Dielectric |
| | | Ca | Co | Fe | [mol %] | | | | Me | Me | | | | Q | zation | Hcj | resistance | constant |
| No. | | x | y | m | Ba | Ca | Co | Fe | (II) | (IV) | D | μ′ | μ″ | μ′/μ″ | Is [mT] | [kA/m] | ρ [Ω · m] | ∈ 1 GHz |
| 1 | * | 0.00 | 2.00 | 8.00 | 5.3 | 0.0 | 10.5 | 84.2 | 10.5 | 0.0 | 10.5 | 1.84 | 0.10 | 18 | 258 | 42 | 2 × 10⁶ | 10 |
| 2 | * | 0.02 | 2.00 | 8.00 | 5.3 | 0.1 | 10.5 | 84.1 | 10.5 | 0.0 | 10.5 | 1.80 | 0.09 | 19 | 271 | 39 | 1 × 10⁷ | 9 |
| 3 | | 0.03 | 2.00 | 8.00 | 5.3 | 0.2 | 10.5 | 84.1 | 10.5 | 0.0 | 10.5 | 1.88 | 0.07 | 27 | 276 | 38 | 4 × 10⁷ | 10 |
| 4 | | 0.10 | 2.00 | 8.00 | 5.2 | 0.5 | 10.5 | 83.8 | 10.5 | 0.0 | 10.5 | 1.98 | 0.04 | 50 | 280 | 28 | 8 × 10⁷ | 10 |
| 5 | | 0.30 | 2.00 | 8.00 | 5.2 | 1.6 | 10.4 | 82.9 | 10.4 | 0.0 | 10.4 | 2.00 | 0.03 | 67 | 281 | 25 | 2 × 10⁸ | 10 |
| 6 | | 0.50 | 2.00 | 8.00 | 5.1 | 2.6 | 10.3 | 82.1 | 10.3 | 0.0 | 10.3 | 1.98 | 0.03 | 66 | 281 | 27 | 9 × 10⁷ | 10 |
| 7 | | 0.80 | 2.00 | 8.00 | 5.1 | 4.0 | 10.1 | 80.8 | 10.1 | 0.0 | 10.1 | 1.80 | 0.03 | 59 | 255 | 35 | 1 × 10⁷ | 10 |
| 8 | | 1.00 | 2.00 | 8.00 | 5.0 | 5.0 | 10.0 | 80.0 | 10.0 | 0.0 | 10.0 | 1.65 | 0.05 | 33 | 201 | 38 | 3 × 10⁶ | 18 |
| 9 | * | 1.20 | 2.00 | 8.00 | 5.0 | 5.9 | 9.9 | 79.2 | 9.9 | 0.0 | 9.9 | 1.49 | 0.11 | 14 | 198 | 57 | 8 × 10³ | 39 |
| 10 | * | 0.30 | 1.00 | 8.00 | 5.5 | 1.6 | 5.5 | 87.4 | 5.5 | 0.0 | 5.5 | 1.49 | 0.12 | 12 | 249 | 36 | 2 × 10⁶ | 33 |
| 11 | | 0.30 | 1.30 | 8.00 | 5.4 | 1.6 | 7.0 | 86.0 | 7.0 | 0.0 | 7.0 | 1.67 | 0.08 | 21 | 255 | 30 | 1 × 10⁸ | 25 |
| 12 | | 0.30 | 1.50 | 8.00 | 5.3 | 1.6 | 8.0 | 85.1 | 8.0 | 0.0 | 8.0 | 1.88 | 0.05 | 38 | 266 | 29 | 2 × 10⁸ | 9 |
| 13 | | 0.30 | 1.80 | 8.00 | 5.2 | 1.6 | 9.4 | 83.8 | 9.4 | 0.0 | 9.4 | 1.95 | 0.04 | 53 | 274 | 28 | 2 × 10⁸ | 9 |
| 14 | | 0.30 | 2.00 | 8.00 | 5.2 | 1.6 | 10.4 | 82.9 | 10.4 | 0.0 | 10.4 | 2.00 | 0.03 | 67 | 281 | 25 | 2 × 10⁸ | 10 |
| 15 | | 0.30 | 2.20 | 8.00 | 5.1 | 1.5 | 11.3 | 82.1 | 11.3 | 0.0 | 11.3 | 1.95 | 0.03 | 74 | 278 | 28 | 2 × 10⁸ | 9 |
| 16 | | 0.30 | 2.50 | 8.00 | 5.1 | 1.5 | 12.6 | 80.8 | 12.6 | 0.0 | 12.6 | 1.91 | 0.01 | 154 | 291 | 29 | 2 × 10⁸ | 9 |
| 17 | | 0.30 | 3.00 | 8.00 | 4.9 | 1.5 | 14.8 | 78.8 | 14.8 | 0.0 | 14.8 | 1.67 | 0.04 | 42 | 288 | 30 | 2 × 10⁸ | 9 |
| 18 | * | 0.30 | 3.20 | 8.00 | 4.9 | 1.5 | 15.6 | 78.0 | 15.6 | 0.0 | 15.6 | 1.49 | 0.11 | 14 | 29 | 41 | 1 × 10⁸ | 11 |
| 19 | * | 0.30 | 2.00 | 6.00 | 6.5 | 2.0 | 13.1 | 78.4 | 13.1 | 0.0 | 13.1 | 1.11 | 0.20 | 6 | 255 | 150 | 5 × 10³ | 254 |
| 20 | | 0.30 | 2.00 | 6.50 | 6.1 | 1.8 | 12.3 | 79.8 | 12.3 | 0.0 | 12.3 | 1.49 | 0.10 | 15 | 261 | 119 | 1 × 10⁷ | 47 |
| 21 | | 0.30 | 2.00 | 7.00 | 5.8 | 1.7 | 11.6 | 80.9 | 11.6 | 0.0 | 11.6 | 1.87 | 0.05 | 37 | 266 | 38 | 8 × 10⁷ | 21 |
| 22 | | 0.30 | 2.00 | 7.50 | 5.5 | 1.6 | 10.9 | 82.0 | 10.9 | 0.0 | 10.9 | 1.98 | 0.04 | 50 | 270 | 30 | 1 × 10⁸ | 21 |
| 23 | | 0.30 | 2.00 | 8.00 | 5.2 | 1.6 | 10.4 | 82.9 | 10.4 | 0.0 | 10.4 | 2.00 | 0.03 | 67 | 281 | 25 | 2 × 10⁸ | 10 |
| 24 | | 0.30 | 2.00 | 8.50 | 4.9 | 1.5 | 9.9 | 83.7 | 9.9 | 0.0 | 9.9 | 1.98 | 0.04 | 50 | 277 | 26 | 7 × 10⁷ | 19 |
| 25 | | 0.30 | 2.00 | 9.00 | 4.7 | 1.4 | 9.4 | 84.5 | 9.4 | 0.0 | 9.4 | 1.68 | 0.07 | 24 | 269 | 31 | 3 × 10⁶ | 21 |
| 26 | * | 0.30 | 2.00 | 9.50 | 4.5 | 1.3 | 9.0 | 85.2 | 9.0 | 0.0 | 9.0 | 1.21 | 0.30 | 4 | 251 | 101 | 2 × 10⁵ | 46 |

TABLE 2
Compositional formula: BaCaₓCo_{y}Fe₂ₘO_{27-δ}

| | | Compositional formula | | | | | | | Crystal phase | | | | |
|---|---|---|---|---|---|---|---|---|---|---|---|---|---|
| | | [mol] | | | Compositional ratio | | | | W-TYPE | M-TYPE | Z-TYPE | Y-TYPE | Spinel |
| | | Ca | Co | Fe | [mol %] | | | | PHASE | PHASE | PHASE | PHASE | phase |
| No. | | x | y | m | Ba | Ca | Co | Fe | BaCo₂Fe₁₆O₂₇ | BaFe₁₂O₁₉ | Ba₃Co₂Fe₂₄O₄₁ | Ba₂Co₂Fe₁₂O₂₂ | CoFe₂O₄ |
| 1 | * | 0.00 | 2.00 | 8.00 | 5.3 | 0.0 | 10.5 | 84.2 | 56 | 33 | | | 11 |
| 2 | * | 0.02 | 2.00 | 8.00 | 5.3 | 0.1 | 10.5 | 84.1 | 70 | 21 | | | 9 |
| 3 | | 0.03 | 2.00 | 8.00 | 5.2 | 0.2 | 10.5 | 84.0 | 84 | 8 | | | 8 |
| 4 | | 0.10 | 2.00 | 8.00 | 5.2 | 0.5 | 10.5 | 83.8 | 100 | | | | |
| 5 | | 0.30 | 2.00 | 8.00 | 5.2 | 1.6 | 10.4 | 82.9 | 100 | | | | |
| 6 | | 0.50 | 2.00 | 8.00 | 5.1 | 2.6 | 10.3 | 82.1 | 100 | | | | |
| 7 | | 0.80 | 2.00 | 8.00 | 5.1 | 4.0 | 10.1 | 80.8 | 98 | | 2 | | |
| 8 | | 1.00 | 2.00 | 8.00 | 5.0 | 5.0 | 10.0 | 80.0 | 74 | | 5 | | 21 |
| 9 | * | 1.20 | 2.00 | 8.00 | 5.0 | 5.9 | 9.9 | 79.2 | 38 | | 20 | | 42 |
| 10 | * | 0.30 | 1.00 | 8.00 | 5.5 | 1.6 | 5.5 | 87.4 | 100 | | | | |
| 11 | | 0.30 | 1.30 | 8.00 | 5.4 | 1.6 | 7.0 | 86.0 | 100 | | | | |
| 12 | | 0.30 | 1.50 | 8.00 | 5.3 | 1.6 | 8.0 | 85.1 | 100 | | | | |
| 13 | | 0.30 | 1.80 | 8.00 | 5.2 | 1.6 | 9.4 | 83.8 | 100 | | | | |
| 14 | | 0.30 | 2.00 | 8.00 | 5.2 | 1.6 | 10.4 | 82.9 | 100 | | | | |
| 15 | | 0.30 | 2.20 | 8.00 | 5.1 | 1.5 | 11.3 | 82.1 | 100 | | | | |
| 16 | | 0.30 | 2.50 | 8.00 | 5.1 | 1.5 | 12.6 | 80.8 | 75 | | | 2 | 23 |
| 17 | | 0.30 | 3.00 | 8.00 | 4.9 | 1.5 | 14.8 | 78.8 | 62 | | | 3 | 35 |
| 18 | * | 0.30 | 3.20 | 8.00 | 4.9 | 1.5 | 15.6 | 78.0 | 39 | | | 5 | 56 |
| 19 | * | 0.30 | 2.00 | 6.00 | 6.5 | 2.0 | 13.1 | 78.4 | 39 | | | 41 | 20 |
| 20 | * | 0.30 | 2.00 | 6.50 | 6.1 | 1.8 | 12.3 | 79.8 | 69 | | | 17 | 14 |
| 21 | | 0.30 | 2.00 | 7.00 | 5.8 | 1.7 | 11.6 | 80.9 | 90 | | | 10 | |
| 22 | | 0.30 | 2.00 | 7.50 | 5.5 | 1.6 | 10.9 | 82.0 | 100 | | | | |
| 23 | | 0.30 | 2.00 | 8.00 | 5.2 | 1.6 | 10.4 | 82.9 | 100 | | | | |
| 24 | | 0.30 | 2.00 | 8.50 | 4.9 | 1.5 | 9.9 | 83.7 | 85 | | | | 15 |
| 25 | | 0.30 | 2.00 | 9.00 | 4.7 | 1.4 | 9.4 | 84.5 | 53 | | | | 47 |
| 26 | * | 0.30 | 2.00 | 9.50 | 4.5 | 1.3 | 9.0 | 85.2 | 39 | | | | 61 |

For example, since Nos. 5, 14, and 23 have the same composition, these have the same characteristics. Note that in Tables 1 and 2, the asterisked samples are comparative examples that are outside the scope of the present invention. The same applies in the tables below.

For compositional formula BaCaₓCo_{y}Fe₂ₘO_{27-δ} where Ca content=x [mol], Co content=y [mol], and Fe content=2m [mol], saturation magnetization 200 mT and coercivity 40 kA/m are achieved at x=0.03 to 1.0 corresponding to Nos. 3 to 8 in Table 1, y=1.3 to 3.0 corresponding to Nos. 11 to 17 in Table 1, and m=7.0 to 9.0 corresponding to Nos. 21 to 25 in Table 1, and, at 1 GHz, Q≥20 and permeability μ′ ≥1.5 are obtained. Thus, the material characteristics are suitable for the function as an inductor at around 1 GHz.

In particular, for compositional formula BaCaₓCo_{y}Fe₂ₘO_{27-δ} where Ca content=x [mol], Co content=y [mol], and Fe content=2m [mol], W-type hexagonal ferrite (BaCo₂Fe₁₆O₂₇) single phase is synthesized and saturation magnetization≥270 mT and coercivity≤30 kA/m are achieved at x=0.1 to 0.5 corresponding to Nos. 4 to 6 in Table 1, y=1.8 to 2.2 corresponding to Nos. 13 to 15 in Table 1, and m=7.5 to 8.5 corresponding to Nos. 22 to 24 in Table 1, and, at 1 GHz, Q≥40 and permeability μ′≥1.8 are obtained. Thus, the material characteristics are more suitable for the function as an inductor at around 1 GHz.

FIGS. 2, 3, and 4 and Table 2 indicate that W-type hexagonal ferrite phase (BaCo₂Fe₁₆O₂₇), which is known to have the highest saturation magnetization among hexagonal ferrites, can be synthesized substantially in single phase by adding Ca and limiting the ranges of the Co content and Fe content, and saturation magnetization≤200 mT, which is higher than that of Y-type ferrite, which has been proven to be hexagonal soft magnetic ferrite suitable for inductors, is obtained. Thus, it is considered that sufficient permeability could be obtained. Moreover, as illustrated in FIG. 5, it is considered that the magnetic loss could be decreased by obtaining a sintered body with a large number of voids.

### Example 2

The compositional formula for the respective powder raw materials was set to (Ba_{1-f}Sr_{f})Caₓ(Co_{y-a}Mᵢᵢₐ) (Fe_{2m-b-c-d-e}M_{iib}M_{iiic}M_{ivd}Mᵥₑ)O_{27-δ}.

The metal ions of Ba, Ca, Co, Fe, Sr, Mᵢᵢ, Mᵢᵢᵢ, and Mᵢᵥ were blended at particular ratios so that the total of the raw materials was 120 g. Here, Mᵢᵢ is a divalent metal ion, and Mᵢᵢ=Co, Cu, Mg, Mn, Ni, or Zn; Mᵢᵢᵢ is a trivalent metal ion, and Mᵢᵢᵢ=Al, Ga, In, or Sc; Mᵢᵥ is a tetravalent metal ion, and Mᵢᵥ=Hf, Si, Sn, Ti, or Zr; and My is a pentavalent or higher metal ion, and Mᵥ=Mo, Nb, Ta, Sb, W, or V, for example. As in Example 1, a dry powder mixture, a sized powder, and a calcined powder were synthesized, the calcined powder was pulverized, molded sheets were prepared, and a sintered body was obtained. Measurements were conducted as in Example 1.

### Example 2-1

Values of the permeability, magnetic loss, Q, saturation magnetization, coercivity, specific resistance, and dielectric constant of representative examples of compositional ratio x concerning Ba and Sr in compositional formula (Ba₁₋ₓSrₓ)Ca_{0.3}Co₂Fe₂ₘO_{27-δ} are indicated in Table 3, and influence on the frequency characteristics of permeability acquired by Ba-site Sr substitution for compositional formula (Ba₁₋ₓSrₓ)Ca_{0.3}Co₂Fe₁₆O_{27-δ} is indicated in FIG. 8. In FIG. 8, Ba=1.0 and Sr=0.0 mol indicate No. 27 in Table 3, Ba=0.5 and Sr=0.5 mol indicate No. 29 in Table 3, and Ba=0.0 and Sr=1.0 mol indicate No. 31 in Table 3.

TABLE 3
Compositional formula: (Ba₁₋ₓSrₓ)Ca_{0.3}Co₂Fe₁₆O_{27-δ}

| | Compositional | | | | | | | | | | | | | | Magnetization | | | |
|---|---|---|---|---|---|---|---|---|---|---|---|---|---|---|---|---|---|---|
| | formula | | | | | | | | | | | Permeability at | | | curve | | | |
| | [mol] | | | | | | | Composite composition | | | | 1 GHz μ = | | | Saturation | Coer- | | |
| | Ba | | Compositional ratio | | | | | amount [mol %] | | | | μ′ − jμ″ | | | magneti- | civity | Specific | Dielectric |
| | 1 − | Sr | [mol %] | | | | | Ba + | Me | Me | | | | Q | zation | Hcj | resistance | constant |
| No. | x | x | Be | Sr | Ca | Co | Fe | Sr | (II) | (IV) | D | μ′ | μ″ | μ′/μ″ | Is [mT] | [kA/m] | ρ [Ω · m] | ∈ 1 GHz |
| 27 | 1.00 | 0.00 | 5.2 | 0.0 | 1.6 | 10.4 | 82.9 | 5.2 | 10.4 | 0.0 | 10.4 | 2.00 | 0.03 | 67 | 281 | 25 | 2 × 10⁸ | 10 |
| 28 | 0.80 | 0.20 | 4.1 | 1.0 | 1.6 | 10.4 | 82.9 | 5.2 | 10.4 | 0.0 | 10.4 | 2.05 | 0.04 | 57 | 285 | 26 | 2 × 10⁸ | 9 |
| 29 | 0.50 | 0.50 | 2.6 | 2.6 | 1.6 | 10.4 | 82.9 | 5.2 | 10.4 | 0.0 | 10.4 | 2.11 | 0.04 | 50 | 290 | 26 | 8 × 10⁷ | 15 |
| 30 | 0.20 | 0.80 | 1.0 | 4.1 | 1.6 | 10.4 | 82.9 | 5.2 | 10.4 | 0.0 | 10.4 | 2.19 | 0.05 | 44 | 292 | 25 | 7 × 10⁷ | 20 |
| 31 | 0.00 | 1.00 | 0.0 | 5.2 | 1.6 | 10.4 | 82.9 | 5.2 | 10.4 | 0.0 | 10.4 | 2.26 | 0.06 | 38 | 300 | 23 | 5 × 10⁷ | 33 |

As indicated in Nos. 27 to 31 in Table 3 and FIG. 8, Ba-site Sr substitution can achieve saturation magnetization≥280 mT, coercivity≤30 kA/m, and, at 1 GHz, permeability μ′>2 and Q≥44, which is high, irrespective to the Sr substitution amount, and thus, the composite can function as an inductor. Sr is known to have a smaller ionic radius than Ba, and it is considered that the permeability μ′ could be increased due to the decrease in lattice constant caused by Sr substitution and the resulting increase in saturation magnetization.

### Example 2-2

The permeability, magnetic loss, Q, saturation magnetization, coercivity, specific resistance, and dielectric constant of representative examples of compositional formula BaCa_{0.3}(Co₂₋ₓMᵢᵢₓ)Fe₁₆O_{27-δ} with Mᵢᵢ=Cu, Mg, Mn, Ni, or Zn are indicated in Table 4, the frequency characteristics of permeability acquired by Co-site Ni substitution in compositional formula BaCa_{0.3}(Co₂₋ₓNiₓ)Fe₁₆O_{27-δ} are indicated in FIG. 9, and the frequency characteristics of permeability acquired by Co-site Zn substitution in compositional formula BaCa_{0.3}(Co₂₋ₓZnₓ)Fe₁₆O_{27-δ} are indicated in FIG. 10. In FIG. 9, Ni=0 mol indicates No. 32 in Table 4, Ni=0.5 mol indicates No. 43 in Table 4, and Ni=1.0 mol indicates No. 44 in Table 4. In FIG. 10, Zn=0 mol indicates No. 32 in Table 4, Zn=0.5 mol indicates No. 46 in Table 4, and Zn=1.0 mol indicates No. 47 in Table 4.

TABLE 4
Compositional formula: BaCa_{0.3}(Co₂₋ₓMeₓ)Fe₁₆O_{27-δ}

| | | | | | | | | Compositional ratio | | | | | | | | |
|---|---|---|---|---|---|---|---|---|---|---|---|---|---|---|---|---|
| | | Compositional formula [mol] Me (II) element | | | | | | [mol %] | | | | | | | | |
| No. | | Co 2 − x | Cu x | Mg x | Mn x | Ni x | Zn x | Ba | Ca | Co | Cu | Mg | Mn | Ni | Zn | Fe |
| 32 | | 2.00 | 0.00 | 0.00 | 0.00 | 0.00 | 0.00 | 5.2 | 1.6 | 10.4 | 0.0 | 0.0 | 0.0 | 0.0 | 0.0 | 82.9 |
| 33 | | 1.80 | 0.20 | 0.00 | 0.00 | 0.00 | 0.00 | 5.2 | 1.6 | 9.3 | 1.0 | 0.0 | 0.0 | 0.0 | 0.0 | 82.9 |
| 34 | | 1.50 | 0.50 | 0.00 | 0.00 | 0.00 | 0.00 | 5.2 | 1.6 | 7.8 | 2.6 | 0.0 | 0.0 | 0.0 | 0.0 | 82.9 |
| 35 | * | 1.00 | 1.00 | 0.00 | 0.00 | 0.00 | 0.00 | 5.2 | 1.6 | 5.2 | 5.2 | 0.0 | 0.0 | 0.0 | 0.0 | 82.9 |
| 36 | | 1.80 | 0.00 | 0.20 | 0.00 | 0.00 | 0.00 | 5.2 | 1.6 | 9.3 | 0.0 | 1.0 | 0.0 | 0.0 | 0.0 | 82.9 |
| 37 | | 1.50 | 0.00 | 0.50 | 0.00 | 0.00 | 0.00 | 5.2 | 1.6 | 7.8 | 0.0 | 2.6 | 0.0 | 0.0 | 0.0 | 82.9 |
| 38 | * | 1.00 | 0.00 | 1.00 | 0.00 | 0.00 | 0.00 | 5.2 | 1.6 | 5.2 | 0.0 | 5.2 | 0.0 | 0.0 | 0.0 | 82.9 |
| 39 | | 1.80 | 0.00 | 0.00 | 0.20 | 0.00 | 0.00 | 5.2 | 1.6 | 9.3 | 0.0 | 0.0 | 1.0 | 0.0 | 0.0 | 82.9 |
| 40 | | 1.50 | 0.00 | 0.00 | 0.50 | 0.00 | 0.00 | 5.2 | 1.6 | 7.8 | 0.0 | 0.0 | 2.6 | 0.0 | 0.0 | 82.9 |
| 41 | * | 1.00 | 0.00 | 0.00 | 1.00 | 0.00 | 0.00 | 5.2 | 1.6 | 5.2 | 0.0 | 0.0 | 5.2 | 0.0 | 0.0 | 82.9 |
| 42 | | 1.80 | 0.00 | 0.00 | 0.00 | 0.20 | 0.00 | 5.2 | 1.6 | 9.3 | 0.0 | 0.0 | 0.0 | 1.0 | 0.0 | 82.9 |
| 43 | | 1.50 | 0.00 | 0.00 | 0.00 | 0.50 | 0.00 | 5.2 | 1.6 | 7.8 | 0.0 | 0.0 | 0.0 | 2.6 | 0.0 | 82.9 |
| 44 | * | 1.00 | 0.00 | 0.00 | 0.00 | 1.00 | 0.00 | 5.2 | 1.6 | 5.2 | 0.0 | 0.0 | 0.0 | 5.2 | 0.0 | 82.9 |
| 45 | | 1.80 | 0.00 | 0.00 | 0.00 | 0.00 | 0.20 | 5.2 | 1.6 | 9.3 | 0.0 | 0.0 | 0.0 | 0.0 | 1.0 | 82.9 |
| 46 | | 1.50 | 0.00 | 0.00 | 0.00 | 0.00 | 0.50 | 5.2 | 1.6 | 7.8 | 0.0 | 0.0 | 0.0 | 0.0 | 2.6 | 82.9 |
| 47 | * | 1.00 | 0.00 | 0.00 | 0.00 | 0.00 | 1.00 | 5.2 | 1.6 | 5.2 | 0.0 | 0.0 | 0.0 | 0.0 | 5.2 | 82.9 |

| | | | | | | | Magnetization | | | |
|---|---|---|---|---|---|---|---|---|---|---|
| | | | | | | | curve | | | |
| | Composite Composition | | | Permeability at 1 | | | Saturation | Coer- | | |
| | amount [mol %] | | | GHz μ = ′ − jμ″ | | | magneti- | civity | Specific | Dielectric |
| | Me | Me | | | | Q | zation | Hcj | resistance | constant |
| No. | (II) | (IV) | D | μ′ | μ″ | μ′/μ″ | Is [mT] | [kA/m] | ρ [Ω · m] | ∈ 1 GHz |
| 32 | 10.4 | 0.0 | 10.4 | 2.00 | 0.03 | 67 | 281 | 25 | 2 × 10⁸ | 10 |
| 33 | 10.4 | 0.0 | 10.4 | 1.78 | 0.06 | 32 | 258 | 30 | 3 × 10⁸ | 10 |
| 34 | 10.4 | 0.0 | 10.4 | 1.62 | 0.08 | 20 | 200 | 40 | 3 × 10⁸ | 9 |
| 35 | 10.4 | 0.0 | 10.4 | 1.49 | 0.32 | 5 | 155 | 106 | 3 × 10⁸ | 9 |
| 36 | 10.4 | 0.0 | 10.4 | 1.89 | 0.05 | 38 | 302 | 21 | 3 × 10⁸ | 10 |
| 37 | 10.4 | 0.0 | 10.4 | 1.72 | 0.08 | 22 | 289 | 36 | 3 × 10⁸ | 9 |
| 38 | 10.4 | 0.0 | 10.4 | 1.51 | 0.28 | 5 | 255 | 69 | 4 × 10⁸ | 9 |
| 39 | 10.4 | 0.0 | 10.4 | 1.82 | 0.05 | 36 | 300 | 21 | 3 × 10⁸ | 7 |
| 40 | 10.4 | 0.0 | 10.4 | 1.64 | 0.08 | 21 | 272 | 37 | 3 × 10⁸ | 6 |
| 41 | 10.4 | 0.0 | 10.4 | 1.40 | 0.21 | 7 | 248 | 71 | 4 × 10⁸ | 9 |
| 42 | 10.4 | 0.0 | 10.4 | 2.19 | 0.06 | 37 | 306 | 30 | 3 × 10⁸ | 10 |
| 43 | 10.4 | 0.0 | 10.4 | 2.82 | 0.14 | 20 | 278 | 26 | 3 × 10⁸ | 9 |
| 44 | 10.4 | 0.0 | 10.4 | 2.89 | 0.31 | 9 | 252 | 10 | 3 × 10⁸ | 9 |
| 45 | 10.4 | 0.0 | 10.4 | 2.09 | 0.06 | 35 | 292 | 25 | 6 × 10⁷ | 10 |
| 46 | 10.4 | 0.0 | 10.4 | 2.78 | 0.14 | 20 | 307 | 22 | 1 × 10⁷ | 11 |
| 47 | 10.4 | 0.0 | 10.4 | 4.63 | 0.68 | 7 | 336 | 7 | 1 × 10⁷ | 12 |

At Co-site Cu substitution amount≤2.6 mol %, as indicated in Nos. 32 to 34 in Table 4, coercivity 40 kA/m, and permeability μ′≥1.5 and Q≥20 at 1 GHz are obtained. At Cu substitution amount=5.2 mol %, as indicated in No. 35 in Table 4, the coercivity increased to coercivity=106 kA/m, and the saturation magnetization decreased to 155 mT; thus, the permeability μ′ decreased at 1 GHz to permeability μ′=1.49, the magnetic loss increased, and Q decreased to Q=5. Thus, the range of the Cu content is set to 0 to 2.6 mol %.

At Co-site Mg substitution amount 2.6 mol %, as indicated in Nos. 32, 36, and 37 in Table 4, coercivity 40 kA/m, and permeability μ′≥1.5 and Q≥20 at 1 GHz are obtained. At Mg substitution amount=5.2 mol %, as indicated in No. 38 in Table 4, the coercivity increased to coercivity=69 kA/m, the permeability at 1 GHz decreased to permeability μ′=1.51, the magnetic loss increased, and Q decreased to Q=5. Thus, the range of the Mg content is set to 0 to 2.6 mol %.

At Co-site Mn substitution amount 2.6 mol %, as indicated in Nos. 32, 39, and 40 in Table 4, the dielectric constant decreased to 7 or 6, and coercivity 40 kA/m, and permeability μ′≥1.5 and Q≥20 at 1 GHz are obtained. At Mn substitution amount=5.2 mol %, as indicated in No. 41 in Table 4, the coercivity increased to coercivity=71 kA/m, the permeability at 1 GHz decreased to permeability μ′=1.40, the magnetic loss increased, and Q decreased to Q=7. Thus, the range of the Mn content is set to 0 to 2.6 mol %.

At Co-site Ni substitution amount 2.6 mol %, as indicated in Nos. 32, 42, and 43 in Table 4 and FIG. 9, permeability μ′≥1.5 and Q≥20 at 1 GHz are obtained. At Ni substitution amount=5.2 mol %, as indicated in No. 44 in Table 4 and FIG. 9, the permeability at 1 GHz increased to permeability μ′=2.89, but the magnetic loss increased, and Q decreased to Q=9. Thus, the range of the Ni content is set to 0 to 2.6 mol %.

At Co-site Zn substitution amount 2.6 mol %, as indicated in Nos. 32, 45, and 46 in Table 4 and FIG. 10, permeability μ′≥1.5 and Q≥20 at 1 GHz are obtained.

At Zn substitution amount=5.2 mol %, as indicated in No. 47 in Table 4 and FIG. 10, the permeability at 1 GHz increased to permeability μ′=4.63, but the magnetic loss increased, and Q decreased to Q=7. Thus, the range of the Zn content is set to 0 to 2.6 mol %.

### Example 2-3

Values of the permeability, magnetic loss, Q, saturation magnetization, coercivity, specific resistance, and dielectric constant of representative examples of compositional formula BaCa_{0.3}Co₂₊ₓMᵢᵥₓFe₁₆₋₂ₓO_{27-δ} with Mᵢᵥ=Ge, Si, Sn, Ti, or Zr+Hf, are indicated in Table 5, the frequency characteristics of permeability acquired by Fe-site Co—Si composite substitution in compositional formula BaCa_{0.3}Co₂₊ₓSiₓFe₁₆₋₂ₓO_{27-δ} are indicated in FIG. 11, and the frequency characteristics of permeability acquired by Fe-site Co—(Zr+Hf) substitution in compositional formula BaCa_{0.3}Co₂₊ₓ(Zr+Hf)ₓFe₁₆₋₂ₓO_{27-δ} are indicated in FIG. 12. In FIG. 11, Co=2, Si=0 mol indicates No. 48 in Table 5, Co=2.5, Si=0.5 mol indicates No. 53 in Table 5, and Co=3.0, Si=1.0 mol indicates No. 54 in Table 5. In FIG. 12, Co=2, Zr+Hf=0 mol indicates No. 48 in Table 5, Co=2.5, Zr+Hf=0.5 mol indicates No. 64 in Table 5, and Co=3.0, Zr+Hf=1.0 mol indicates No. 65 in Table 5.

TABLE 5
Compositional formula: BaCa_{0.3}Co2₊ₓMeₓFe₁₆₋₂ₓO_{27-δ}

| | | Compositional formula | | | | | | | | | | | | | | | |
|---|---|---|---|---|---|---|---|---|---|---|---|---|---|---|---|---|---|
| | | [mol] | | | | | | | | | | | | | | | |
| | | | Me | | | | | | Compositional ratio | | | | | | | | |
| | | | (II) | Me (IV) element | | | | | [mol %] | | | | | | | | |
| | | Fe | Co | Ge | Si | Sn | Ti | Zr + | | | | | | | | Zr + | |
| No. | | 16 − 2x | 2 + x | x | x | x | x | Hf x | Ba | Ca | Co | Ge | Si | Sn | Ti | Hf | Fe |
| 48 | | 16.00 | 2.00 | 0.00 | 0.00 | 0.00 | 0.00 | 0.00 | 5.2 | 1.6 | 10.4 | 0.0 | 0.0 | 0.0 | 0.0 | 0.0 | 82.9 |
| 49 | | 15.60 | 2.20 | 0.20 | 0.00 | 0.00 | 0.00 | 0.00 | 5.2 | 1.6 | 11.4 | 1.0 | 0.0 | 0.0 | 0.0 | 0.0 | 80.8 |
| 50 | | 15.00 | 2.50 | 0.50 | 0.00 | 0.00 | 0.00 | 0.00 | 5.2 | 1.6 | 13.0 | 2.6 | 0.0 | 0.0 | 0.0 | 0.0 | 77.7 |
| 51 | * | 14.00 | 3.00 | 1.00 | 0.00 | 0.00 | 0.00 | 0.00 | 5.2 | 1.6 | 15.5 | 5.2 | 0.0 | 0.0 | 0.0 | 0.0 | 72.5 |
| 52 | | 15.60 | 2.20 | 0.00 | 0.20 | 0.00 | 0.00 | 0.00 | 5.2 | 1.6 | 11.4 | 0.0 | 1.0 | 0.0 | 0.0 | 0.0 | 80.8 |
| 53 | | 15.00 | 2.50 | 0.00 | 0.50 | 0.00 | 0.00 | 0.00 | 5.2 | 1.6 | 13.0 | 0.0 | 2.6 | 0.0 | 0.0 | 0.0 | 77.7 |
| 54 | * | 14.00 | 3.00 | 0.00 | 1.00 | 0.00 | 0.00 | 0.00 | 5.2 | 1.6 | 15.5 | 0.0 | 5.2 | 0.0 | 0.0 | 0.0 | 72.5 |
| 55 | | 15.60 | 2.20 | 0.00 | 0.00 | 0.20 | 0.00 | 0.00 | 5.2 | 1.6 | 11.4 | 0.0 | 0.0 | 1.0 | 0.0 | 0.0 | 80.8 |
| 56 | | 15.00 | 2.50 | 0.00 | 0.00 | 0.50 | 0.00 | 0.00 | 5.2 | 1.6 | 13.0 | 0.0 | 0.0 | 2.6 | 0.0 | 0.0 | 77.7 |
| 57 | | 14.00 | 3.00 | 0.00 | 0.00 | 1.00 | 0.00 | 0.00 | 5.2 | 1.6 | 15.5 | 0.0 | 0.0 | 5.2 | 0.0 | 0.0 | 72.5 |
| 58 | * | 13.00 | 3.50 | 0.00 | 0.00 | 1.50 | 0.00 | 0.00 | 5.2 | 1.6 | 18.1 | 0.0 | 0.0 | 7.8 | 0.0 | 0.0 | 67.4 |
| 59 | * | 12.00 | 4.00 | 0.00 | 0.00 | 2.00 | 0.00 | 0.00 | 5.2 | 1.6 | 20.7 | 0.0 | 0.0 | 10.4 | 0.0 | 0.0 | 62.2 |
| 60 | | 15.60 | 2.20 | 0.00 | 0.00 | 0.00 | 0.20 | 0.00 | 5.2 | 1.6 | 11.4 | 0.0 | 0.0 | 0.0 | 1.0 | 0.0 | 80.8 |
| 61 | | 15.00 | 2.50 | 0.00 | 0.00 | 0.00 | 0.50 | 0.00 | 5.2 | 1.6 | 13.0 | 0.0 | 0.0 | 0.0 | 2.6 | 0.0 | 77.7 |
| 62 | * | 14.00 | 3.00 | 0.00 | 0.00 | 0.00 | 1.00 | 0.00 | 5.2 | 1.6 | 15.5 | 0.0 | 0.0 | 0.0 | 5.2 | 0.0 | 72.5 |
| 63 | | 15.60 | 2.20 | 0.00 | 0.00 | 0.00 | 0.00 | 0.20 | 5.2 | 1.6 | 11.4 | 0.0 | 0.0 | 0.0 | 0.0 | 1.0 | 80.8 |
| 64 | | 15.00 | 2.50 | 0.00 | 0.00 | 0.00 | 0.00 | 0.50 | 5.2 | 1.6 | 13.0 | 0.0 | 0.0 | 0.0 | 0.0 | 2.6 | 77.7 |
| 65 | | 14.00 | 3.00 | 0.00 | 0.00 | 0.00 | 0.00 | 1.00 | 5.2 | 1.6 | 15.5 | 0.0 | 0.0 | 0.0 | 0.0 | 5.2 | 72.5 |
| 66 | * | 13.00 | 3.50 | 0.00 | 0.00 | 0.00 | 0.00 | 1.50 | 5.2 | 1.6 | 18.1 | 0.0 | 0.0 | 0.0 | 0.0 | 7.8 | 67.4 |
| 67 | * | 12.00 | 4.00 | 0.00 | 0.00 | 0.00 | 0.00 | 2.00 | 5.2 | 1.6 | 20.7 | 0.0 | 0.0 | 0.0 | 0.0 | 10.4 | 62.2 |

| | | | | | | | Magnetization | | | |
|---|---|---|---|---|---|---|---|---|---|---|
| | | | | Permeability at | | | curve | | | |
| | Composite composition | | | 1 GHz μ = | | | Saturation | Coer- | | |
| | amount [mol %] | | | μ′ − jμ″ | | | magneti- | civity | Specific | Dielectric |
| | Me | Me | | | | Q | zation | Hcj | resistance | constant |
| No. | (II) | (IV) | D | μ′ | μ″ | μ′/μ″ | Is [mT] | [kA/m] | ρ [Ω · m] | ∈ 1 GHz |
| 48 | 10.4 | 0.0 | 10.4 | 2.00 | 0.03 | 67 | 281 | 25 | 2 × 10⁸ | 10 |
| 49 | 11.4 | 1.0 | 10.4 | 1.99 | 0.04 | 50 | 288 | 26 | 3 × 10⁸ | 10 |
| 50 | 13.0 | 2.6 | 10.4 | 1.88 | 0.06 | 31 | 274 | 31 | 3 × 10⁸ | 9 |
| 51 | 15.5 | 5.2 | 10.4 | 1.27 | 0.27 | 5 | 209 | 33 | 3 × 10⁸ | 9 |
| 52 | 11.4 | 1.0 | 10.4 | 2.19 | 0.07 | 31 | 289 | 20 | 3 × 10⁸ | 10 |
| 53 | 13.0 | 2.6 | 10.4 | 2.64 | 0.11 | 23 | 276 | 19 | 3 × 10⁸ | 9 |
| 54 | 15.5 | 5.2 | 10.4 | 2.61 | 0.16 | 16 | 251 | 20 | 3 × 10⁸ | 9 |
| 55 | 11.4 | 1.0 | 10.4 | 1.89 | 0.04 | 47 | 291 | 27 | 3 × 10⁸ | 10 |
| 56 | 13.0 | 2.6 | 10.4 | 1.82 | 0.05 | 36 | 309 | 31 | 3 × 10⁸ | 9 |
| 57 | 15.5 | 5.2 | 10.4 | 1.70 | 0.06 | 28 | 312 | 34 | 3 × 10⁸ | 9 |
| 58 | 18.1 | 7.8 | 10.4 | 1.57 | 0.15 | 10 | 277 | 49 | 4 × 10⁸ | 9 |
| 59 | 20.7 | 10.4 | 10.4 | 1.16 | 0.25 | 5 | 189 | 88 | 4 × 10⁸ | 9 |
| 60 | 11.4 | 1.0 | 10.4 | 1.92 | 0.04 | 48 | 289 | 26 | 3 × 10⁸ | 10 |
| 61 | 13.0 | 2.6 | 10.4 | 1.89 | 0.05 | 38 | 275 | 30 | 3 × 10⁸ | 9 |
| 62 | 15.5 | 5.2 | 10.4 | 1.29 | 0.25 | 5 | 208 | 32 | 3 × 10⁸ | 9 |
| 63 | 11.4 | 1.0 | 10.4 | 2.01 | 0.04 | 51 | 296 | 25 | 3 × 10⁸ | 10 |
| 64 | 13.0 | 2.6 | 10.4 | 2.03 | 0.05 | 38 | 310 | 26 | 3 × 10⁸ | 9 |
| 65 | 15.5 | 5.2 | 10.4 | 1.54 | 0.06 | 25 | 311 | 39 | 3 × 10⁸ | 9 |
| 66 | 18.1 | 7.8 | 10.4 | 1.49 | 0.12 | 12 | 276 | 43 | 4 × 10⁸ | 9 |
| 67 | 20.7 | 10.4 | 10.4 | 1.26 | 0.24 | 5 | 188 | 83 | 4 × 10⁸ | 9 |

At Fe-site Ge substitution amount≤2.6 mol %, as indicated in Nos. 48 to 50 in Table 5, permeability μ′≥1.5 and Q≥20 at 1 GHz are obtained, and the permeability is low. At Ge substitution amount=5.2 mol %, as indicated in No. 51 in Table 5, both the permeability and Q decreased to permeability μ′≥1.27 and Q≥20 at 1 GHz. Thus, the range of the Gen content is set to 0 to 2.6 mol %.

At Fe-site Si substitution amount≤2.6 mol %, as indicated in Nos. 48, 52, and 53 in Table 5 and FIG. 11, permeability μ′≥1.5 and Q≥20 at 1 GHz are obtained, and the permeability is high. At Si substitution amount=5.2 mol %, as indicated in No. 54 in Table 5 and FIG. 11, the magnetic loss at 1 GHz increased, and Q decreased to Q=16. Thus, the range of the Cu content is set to 0 to 2.6 mol %.

At Fe-site Sn substitution amount 5.2 mol %, as indicated in Nos. 48 and 55 to 57 in Table 5, permeability μ′≥1.5 and Q≥20 at 1 GHz are obtained, and the permeability is low. At Sn substitution amount=7.8 mol %, as indicated in No. 58 in Table 5, both the permeability and Q decreased to permeability μ′=1.57 and Q=10 at 1 GHz. Thus, the range of the Sn content is set to 0 to 5.2 mol %.

At Fe-site Ti substitution amount 2.6 mol %, as indicated in Nos. 48, 60, and 61 in Table 5, permeability μ′≥1.5 and Q≥20 at 1 GHz are obtained, and the permeability is low. At Ti substitution amount=5.2 mol %, as indicated in No. 62 in Table 5, both the permeability and Q decreased to permeability μ′=1.29 and Q=5 at 1 GHz. Thus, the range of the Ti content is set to 0 to 2.6 mol %.

At Fe-site Zr+Hf substitution amount 5.2 mol %, as indicated in Nos. 48 and 63 to 65 in Table 5 and FIG. 12, permeability μ′≥1.5 and Q≥20 at 1 GHz are obtained, and the permeability is low. At Zr+Hf substitution amount=7.8 mol %, as indicated in No. 66 in Table 5 and FIG. 12, both the permeability and Q decreased to permeability μ′=1.49 and Q=12 at 1 GHz. Thus, the range of the Zr+Hf content is set to 0 to 5.2 mol %.

### Example 2-4

The values of permeability, magnetic loss, Q, saturation magnetization, coercivity, specific resistance, and dielectric constant of representative examples of compositional formula BaCa_{0.3}Co₂(Fe₁₆₋ₓMᵢᵢᵢₓ)O_{27-δ} with Mᵢᵢᵢ=Ga, In, or Sc are indicated in Table 6. The frequency characteristics of permeability acquired by Fe-site Sc substitution in compositional formula BaCa_{0.3}Co₂(Fe₁₆₋ₓScₓ)O_{27-δ} are illustrated in FIG. 13.

In FIG. 13, Sc=0 mol indicates No. 68 in Table 6, Sc=0.5 mol indicates No. 83 in Table 6, and Sc=1.0 mol indicates No. 84 in Table 6.

TABLE 6
Compositional formula: BaCa_{0.3}Co₂(Fe₁₆₋ₓMeₓ)O_{27-δ}

| | | Compositional formula | | | | | | | | | | | | | Composite composition | | |
|---|---|---|---|---|---|---|---|---|---|---|---|---|---|---|---|---|---|
| | | [mol] | | | | | Compositional ratio | | | | | | | | amount [mol %] | | |
| | | | Me (III) element | | | | [mol %] | | | | | | | | Me | Me | |
| No. | | Fe 16 − x | Al x | Ga x | In x | Sc x | Ba | Ca | Co | Al | Ga | In | Sc | Fe | (II) | (IV) | D |
| 68 | | 16.00 | 0.00 | 0.00 | 0.00 | 0.00 | 5.2 | 1.6 | 10.4 | 0.0 | 0.0 | 0.0 | 0.0 | 82.9 | 10.4 | 0.0 | 10.4 |
| 69 | | 15.90 | 0.10 | 0.00 | 0.00 | 0.00 | 5.2 | 1.6 | 10.4 | 0.5 | 0.0 | 0.0 | 0.0 | 82.4 | 10.4 | 0.0 | 10.4 |
| 70 | | 15.50 | 0.50 | 0.00 | 0.00 | 0.00 | 5.2 | 1.6 | 10.4 | 2.6 | 0.0 | 0.0 | 0.0 | 80.3 | 10.4 | 0.0 | 10.4 |
| 71 | | 15.00 | 1.00 | 0.00 | 0.00 | 0.00 | 5.2 | 1.6 | 10.4 | 5.2 | 0.0 | 0.0 | 0.0 | 77.7 | 10.4 | 0.0 | 10.4 |
| 72 | * | 14.50 | 1.50 | 0.00 | 0.00 | 0.00 | 5.2 | 1.6 | 10.4 | 7.8 | 0.0 | 0.0 | 0.0 | 75.1 | 10.4 | 0.0 | 10.4 |
| 73 | | 15.90 | 0.00 | 0.10 | 0.00 | 0.00 | 5.2 | 1.6 | 10.4 | 0.0 | 0.5 | 0.0 | 0.0 | 82.4 | 10.4 | 0.0 | 10.4 |
| 74 | | 15.50 | 0.00 | 0.50 | 0.00 | 0.00 | 5.2 | 1.6 | 10.4 | 0.0 | 2.6 | 0.0 | 0.0 | 80.3 | 10.4 | 0.0 | 10.4 |
| 75 | | 15.00 | 0.00 | 1.00 | 0.00 | 0.00 | 5.2 | 1.6 | 10.4 | 0.0 | 5.2 | 0.0 | 0.0 | 77.7 | 10.4 | 0.0 | 10.4 |
| 76 | * | 14.50 | 0.00 | 1.50 | 0.00 | 0.00 | 5.2 | 1.6 | 10.4 | 0.0 | 7.8 | 0.0 | 0.0 | 75.1 | 10.4 | 0.0 | 10.4 |
| 77 | | 15.90 | 0.00 | 0.00 | 0.10 | 0.00 | 5.2 | 1.6 | 10.4 | 0.0 | 0.0 | 0.5 | 0.0 | 82.4 | 10.4 | 0.0 | 10.4 |
| 78 | | 15.50 | 0.00 | 0.00 | 0.50 | 0.00 | 5.2 | 1.6 | 10.4 | 0.0 | 0.0 | 2.6 | 0.0 | 80.3 | 10.4 | 0.0 | 10.4 |
| 79 | | 15.00 | 0.00 | 0.00 | 1.00 | 0.00 | 5.2 | 1.6 | 10.4 | 0.0 | 0.0 | 5.2 | 0.0 | 77.7 | 10.4 | 0.0 | 10.4 |
| 80 | | 14.50 | 0.00 | 0.00 | 1.50 | 0.00 | 5.2 | 1.6 | 10.4 | 0.0 | 0.0 | 7.8 | 0.0 | 75.1 | 10.4 | 0.0 | 10.4 |
| 81 | * | 14.00 | 0.00 | 0.00 | 2.00 | 0.00 | 5.2 | 1.6 | 10.4 | 0.0 | 0.0 | 10.4 | 0.0 | 72.5 | 10.4 | 0.0 | 10.4 |
| 82 | | 15.90 | 0.00 | 0.00 | 0.00 | 0.10 | 5.2 | 1.6 | 10.4 | 0.0 | 0.0 | 0.0 | 0.5 | 82.4 | 10.4 | 0.0 | 10.4 |
| 83 | | 15.50 | 0.00 | 0.00 | 0.00 | 0.50 | 5.2 | 1.6 | 10.4 | 0.0 | 0.0 | 0.0 | 2.6 | 80.3 | 10.4 | 0.0 | 10.4 |
| 84 | | 15.00 | 0.00 | 0.00 | 0.00 | 1.00 | 5.2 | 1.6 | 10.4 | 0.0 | 0.0 | 0.0 | 5.2 | 77.7 | 10.4 | 0.0 | 10.4 |
| 85 | | 14.50 | 0.00 | 0.00 | 0.00 | 1.50 | 5.2 | 1.6 | 10.4 | 0.0 | 0.0 | 0.0 | 7.8 | 75.1 | 10.4 | 0.0 | 10.4 |
| 86 | * | 14.00 | 0.00 | 0.00 | 0.00 | 2.00 | 5.2 | 1.6 | 10.4 | 0.0 | 0.0 | 0.0 | 10.4 | 72.5 | 10.4 | 0.0 | 10.4 |

| | | | | Magnetization curve | | | |
|---|---|---|---|---|---|---|---|
| | Permeability at 1 | | | Saturation | Coerci- | | |
| | GHz μ = μ′ − jμ″ | | | magneti- | vity | Specific | Dielectric |
| | | | Q | zation | Hcj | resistance | constant |
| No. | μ′ | μ″ | μ′/μ″ | Is [mT] | [kA/m] | ρ [Ω · m] | ∈ 1 GHz |
| 68 | 2.00 | 0.03 | 67 | 281 | 25 | 2 × 10⁸ | 10 |
| 69 | 1.99 | 0.04 | 57 | 273 | 29 | 3 × 10⁸ | 10 |
| 70 | 1.89 | 0.04 | 47 | 255 | 35 | 3 × 10⁸ | 9 |
| 71 | 1.79 | 0.05 | 36 | 232 | 38 | 3 × 10⁸ | 9 |
| 72 | 1.22 | 0.20 | 6 | 67 | 131 | 4 × 10⁸ | 9 |
| 73 | 1.94 | 0.04 | 55 | 273 | 29 | 3 × 10⁸ | 10 |
| 74 | 1.83 | 0.04 | 46 | 254 | 35 | 3 × 10⁸ | 9 |
| 75 | 1.76 | 0.05 | 35 | 231 | 45 | 3 × 10⁸ | 9 |
| 76 | 1.31 | 0.20 | 7 | 77 | 130 | 4 × 10⁸ | 9 |
| 77 | 1.98 | 0.05 | 40 | 277 | 29 | 3 × 10⁸ | 10 |
| 78 | 1.89 | 0.04 | 47 | 260 | 32 | 3 × 10⁸ | 9 |
| 79 | 1.76 | 0.03 | 59 | 226 | 32 | 3 × 10⁸ | 9 |
| 80 | 1.65 | 0.06 | 28 | 201 | 34 | 4 × 10⁸ | 9 |
| 81 | 1.49 | 0.18 | 8 | 109 | 61 | 4 × 10⁸ | 9 |
| 82 | 2.01 | 0.04 | 52 | 276 | 29 | 3 × 10⁸ | 10 |
| 83 | 1.80 | 0.03 | 54 | 248 | 32 | 3 × 10⁸ | 9 |
| 84 | 1.74 | 0.04 | 46 | 228 | 32 | 3 × 10⁸ | 9 |
| 85 | 1.62 | 0.06 | 29 | 203 | 35 | 4 × 10⁸ | 9 |
| 86 | 1.54 | 0.17 | 9 | 175 | 62 | 4 × 10⁸ | 9 |

At Fe-site Al substitution amount 5.2 mol %, as indicated in Nos. 68 to 71 in Table 6, permeability μ′≥1.5 and Q≥20 at 1 GHz are obtained, and the permeability decreases gradually. At Al substitution amount=7.8 mol %, as indicated in No. 72 in Table 6, the permeability at 1 GHz decreased to permeability μ′=1.22, the magnetic loss increased, and Q decreased to Q=6. Thus, the Al content is set to 0 to 5.2 mol %.

At Fe-site Ga substitution amount 5.2 mol %, as indicated in Nos. 68 and 73 to 75 in Table 6, permeability μ′≥1.5 and Q≥20 at 1 GHz are obtained, and the permeability decreases gradually. At Ga substitution amount=7.8 mol %, as indicated in No. 76 in Table 6, the permeability at 1 GHz decreased to permeability μ′=1.31, the magnetic loss increased, and Q decreased to Q=7. Thus, the range of the Ga content is set to 0 to 5.2 mol %.

At Fe-site In substitution amount 7.8 mol %, as indicated in Nos. 68 and 77 to 80 in Table 6, permeability μ′≥1.5 and Q≥20 at 1 GHz are obtained, and the permeability decreases gradually. At In substitution amount=10.4 mol %, as indicated in No. 81 in Table 6, the permeability at 1 GHz decreased to permeability μ′=1.49, the magnetic loss increased, and Q decreased to Q=8. Thus, the range of the In content is set to 0 to 7.8 mol %.

At Fe-site Sc substitution amount 7.8 mol %, as indicated in Nos. 68 and 82 to 85 in Table 6 and FIG. 13, permeability μ′≥1.5 and Q≥20 at 1 GHz are obtained, and the permeability decreases gradually. At Sc substitution amount=10.4 mol %, as indicated in No. 86 in Table 6, the permeability at 1 GHz decreased to permeability μ′=1.54, the magnetic loss increased, and Q decreased to Q=9. Thus, the range of the Sc content is set to 0 to 7.8 mol %.

### Example 2-5

Values of permeability, magnetic loss, Q, saturation magnetization, coercivity, specific resistance, and dielectric constant for compositional formula SrCaₓCo₂Fe₂ₘO_{27-δ} when Ba sites were fully substituted with Sr, Ca content x=0.30, and the Fe content m was varied are indicated in Table 7.

TABLE 7
Compositional formula: SrCaₓCo₂Fe₂ₘO₂₇_{-δ}

| | | | | | | | | | | | | | | | Magnetization | | | |
|---|---|---|---|---|---|---|---|---|---|---|---|---|---|---|---|---|---|---|
| | | | | | | | | Composite | | | | | | | curve | | | |
| | | Compositional | | | | | | composition | | | | Permeability at 1 | | | Saturation | Coer- | | |
| | | formula [mol] | | Compositional | | | | amount [mol %] | | | | GHz μ = μ′ − jμ″ | | | magneti- | civity | Specific | Dielectric |
| | | Ca | Fe | ratio [mol %] | | | | Ba + | Me | Me | | | | Q | zation | Hcj | resistance | constant |
| No. | | x | m | Sr | Ca | Co | Fe | Sr | (II) | (IV) | D | μ′ | μ″ | μ′/μ″ | Is [mT] | [kA/m] | ρ [Ω · m] | ∈ 1 GHz |
| 87 | * | 0.30 | 6.00 | 6.5 | 2.0 | 13.1 | 78.4 | 6.5 | 13.1 | 0.0 | 13.1 | 1.49 | 0.25 | 6 | 260 | 30 | 2 × 10³ | 79 |
| 88 | * | 0.30 | 6.50 | 6.1 | 1.8 | 12.3 | 79.8 | 6.1 | 12.3 | 0.0 | 12.3 | 2.40 | 0.15 | 16 | 279 | 3 | 3 × 10⁴ | 39 |
| 89 | | 0.30 | 7.00 | 5.8 | 1.7 | 11.6 | 80.9 | 5.8 | 11.6 | 0.0 | 11.6 | 2.46 | 0.07 | 35 | 286 | 3 | 5 × 10⁴ | 31 |
| 90 | | 0.30 | 7.50 | 5.5 | 1.6 | 10.9 | 82.0 | 5.5 | 10.9 | 0.0 | 10.9 | 2.48 | 0.04 | 62 | 289 | 3 | 2 × 10⁴ | 39 |
| 91 | | 0.30 | 8.00 | 5.2 | 1.6 | 10.4 | 82.9 | 5.2 | 10.4 | 0.0 | 10.4 | 2.49 | 0.05 | 50 | 292 | 3 | 5 × 10³ | 53 |
| 92 | | 0.30 | 8.50 | 4.9 | 1.5 | 9.9 | 83.7 | 4.9 | 9.9 | 0.0 | 9.9 | 1.98 | 0.10 | 20 | 290 | 8 | 3 × 10³ | 88 |
| 93 | * | 0.30 | 9.00 | 4.7 | 1.4 | 9.4 | 84.5 | 4.7 | 9.4 | 0.0 | 9.4 | 1.45 | 0.30 | 5 | 277 | 30 | 9 × 10² | 158 |

When Ca content=0.30 mol %, at an Sr content of 4.9 mol % to 5.8 mol %, permeability μ′≥1.5 and Q≥20 at 1 GHz are obtained as indicated in Nos. 89 to 92 in Table 7. At Sr content=6.1 mol %, Q decreases to Q<20 as indicated in No. 88 in Table 7. At Sr content=6.5 mol %, as indicated in No. 87 in Table 7, the permeability at 1 GHz decreased to permeability μ′=1.49, the magnetic loss increased, and Q decreased to Q=6. At Sr content=4.7 mol %, as indicated in No. 93 in Table 7, the permeability at 1 GHz decreased to permeability μ′=1.45, the magnetic loss increased, and Q decreased to Q=5.

### Example 2-6

Values of permeability, magnetic loss, Q, saturation magnetization, coercivity, specific resistance, and dielectric constant of representative examples of compositional formula BaCa_{0.3}Co₂Ni₂ₓMᵥₓFe₁₆₋₃ₓO_{27-δ} with M_{y}=Mo, Nb+Ta, Sb, W, or V are indicated in Table 8.

TABLE 8
Compositional formula: BaCa_{0.3}Co₂Ni₂ₓMeₓ Fe₁₆₋₃ₓO_{27-δ}

| | | | | | | | Compositional ratio | | | | | | | | | |
|---|---|---|---|---|---|---|---|---|---|---|---|---|---|---|---|---|
| | | Compositional formula [mol] Me (V) element | | | | | [mol %] | | | | | | | | | |
| No. | | Mo x | Nb + Ta x | Sb x | W x | V x | Ba | Ca | Co | Ni | Mo | Nb + Ta | Sb | W | V | Fe |
| 94 | | 0.00 | 0.00 | 0.00 | 0.00 | 0.00 | 5.2 | 1.6 | 10.4 | 0.0 | 0.0 | 0.0 | 0.0 | 0.0 | 0.0 | 82.9 |
| 95 | | 0.25 | 0.00 | 0.00 | 0.00 | 0.00 | 5.2 | 1.6 | 10.4 | 2.6 | 1.3 | 0.0 | 0.0 | 0.0 | 0.0 | 79.0 |
| 96 | | 0.50 | 0.00 | 0.00 | 0.00 | 0.00 | 5.2 | 1.6 | 10.4 | 5.2 | 2.6 | 0.0 | 0.0 | 0.0 | 0.0 | 75.1 |
| 97 | * | 1.00 | 0.00 | 0.00 | 0.00 | 0.00 | 5.2 | 1.6 | 10.4 | 10.4 | 5.2 | 0.0 | 0.0 | 0.0 | 0.0 | 67.4 |
| 98 | | 0.00 | 0.25 | 0.00 | 0.00 | 0.00 | 5.2 | 1.6 | 10.4 | 2.6 | 0.0 | 1.3 | 0.0 | 0.0 | 0.0 | 79.0 |
| 99 | | 0.00 | 0.50 | 0.00 | 0.00 | 0.00 | 5.2 | 1.6 | 10.4 | 5.2 | 0.0 | 2.6 | 0.0 | 0.0 | 0.0 | 75.1 |
| 100 | * | 0.00 | 1.00 | 0.00 | 0.00 | 0.00 | 5.2 | 1.6 | 10.4 | 10.4 | 0.0 | 5.2 | 0.0 | 0.0 | 0.0 | 67.4 |
| 101 | | 0.00 | 0.00 | 0.25 | 0.00 | 0.00 | 5.2 | 1.6 | 10.4 | 2.6 | 0.0 | 0.0 | 1.3 | 0.0 | 0.0 | 79.0 |
| 102 | | 0.00 | 0.00 | 0.50 | 0.00 | 0.00 | 5.2 | 1.6 | 10.4 | 5.2 | 0.0 | 0.0 | 2.6 | 0.0 | 0.0 | 75.1 |
| 103 | * | 0.00 | 0.00 | 1.00 | 0.00 | 0.00 | 5.2 | 1.6 | 10.4 | 10.4 | 0.0 | 0.0 | 5.2 | 0.0 | 0.0 | 67.4 |
| 104 | | 0.00 | 0.00 | 0.00 | 0.25 | 0.00 | 5.2 | 1.6 | 10.4 | 2.6 | 0.0 | 0.0 | 0.0 | 1.3 | 0.0 | 79.0 |
| 105 | | 0.00 | 0.00 | 0.00 | 0.50 | 0.00 | 5.2 | 1.6 | 10.4 | 5.2 | 0.0 | 0.0 | 0.0 | 2.6 | 0.0 | 75.1 |
| 106 | * | 0.00 | 0.00 | 0.00 | 1.00 | 0.00 | 5.2 | 1.6 | 10.4 | 10.4 | 0.0 | 0.0 | 0.0 | 5.2 | 0.0 | 67.4 |
| 107 | | 0.00 | 0.00 | 0.00 | 0.00 | 0.25 | 5.2 | 1.6 | 10.4 | 2.6 | 0.0 | 0.0 | 0.0 | 0.0 | 1.3 | 79.0 |
| 108 | | 0.00 | 0.00 | 0.00 | 0.00 | 0.50 | 5.2 | 1.6 | 10.4 | 5.2 | 0.0 | 0.0 | 0.0 | 0.0 | 2.6 | 75.1 |
| 109 | * | 0.00 | 0.00 | 0.00 | 0.00 | 1.00 | 5.2 | 1.6 | 10.4 | 10.4 | 0.0 | 0.0 | 0.0 | 0.0 | 5.2 | 67.4 |

| | Composite amount | | | | Permeability at 1 | | | Magnetization curve | | | |
|---|---|---|---|---|---|---|---|---|---|---|---|
| | composition [mol %] | | | | GHz μ = μ′ − jμ″ | | | Saturation | Coercivity | Specific | Dielectric |
| | Me | Me | Me | | | | Q | magnetization | Hcj | resistance | constant |
| No. | (II) | (IV) | (V) | D | μ′ | μ″ | μ′/μ″ | Is [mT] | [kA/m] | ρ [Ω · m] | ∈ 1 GHz |
| 94 | 10.4 | 0.0 | 0.0 | 10.4 | 2.00 | 0.03 | 67 | 281 | 25 | 2 × 10⁸ | 10 |
| 95 | 13.0 | 0.0 | 1.3 | 10.4 | 2.19 | 0.07 | 31 | 289 | 20 | 3 × 10⁸ | 10 |
| 96 | 15.5 | 0.0 | 2.6 | 10.4 | 2.64 | 0.11 | 23 | 276 | 19 | 3 × 10⁸ | 9 |
| 97 | 20.7 | 0.0 | 5.2 | 10.4 | 2.61 | 0.16 | 16 | 251 | 20 | 3 × 10⁸ | 9 |
| 98 | 13.0 | 0.0 | 1.3 | 10.4 | 2.19 | 0.07 | 31 | 289 | 20 | 3 × 10⁸ | 10 |
| 99 | 15.5 | 0.0 | 2.6 | 10.4 | 2.64 | 0.11 | 23 | 276 | 19 | 3 × 10⁸ | 9 |
| 100 | 20.7 | 0.0 | 5.2 | 10.4 | 2.61 | 0.16 | 16 | 251 | 20 | 3 × 10⁸ | 9 |
| 101 | 13.0 | 0.0 | 1.3 | 10.4 | 2.19 | 0.07 | 31 | 289 | 20 | 3 × 10⁸ | 10 |
| 102 | 15.5 | 0.0 | 2.6 | 10.4 | 2.64 | 0.11 | 23 | 276 | 19 | 3 × 10⁸ | 9 |
| 103 | 20.7 | 0.0 | 5.2 | 10.4 | 2.61 | 0.16 | 16 | 251 | 20 | 3 × 10⁸ | 9 |
| 104 | 13.0 | 0.0 | 1.3 | 10.4 | 2.19 | 0.07 | 31 | 289 | 20 | 3 × 10⁸ | 10 |
| 105 | 15.5 | 0.0 | 2.6 | 10.4 | 2.64 | 0.11 | 23 | 276 | 19 | 3 × 10⁸ | 9 |
| 106 | 20.7 | 0.0 | 5.2 | 10.4 | 2.61 | 0.16 | 16 | 251 | 20 | 3 × 10⁸ | 9 |
| 107 | 13.0 | 0.0 | 1.3 | 10.4 | 2.19 | 0.07 | 31 | 289 | 20 | 3 × 10⁸ | 10 |
| 108 | 15.5 | 0.0 | 2.6 | 10.4 | 2.64 | 0.11 | 23 | 276 | 19 | 3 × 10⁸ | 9 |
| 109 | 20.7 | 0.0 | 5.2 | 10.4 | 2.61 | 0.16 | 16 | 251 | 20 | 3 × 10⁸ | 9 |

At Fe-site Mo substitution amount 2.6 mol %, as indicated in Nos. 94 to 96 in Table 8, permeability μ′≥1.5 and Q≥20 at 1 GHz are obtained, and the permeability decreases gradually. At Mo substitution amount=5.2 mol %, Q decreased to Q=16 as indicated in No. 97 in Table 8.

At Fe-site Nb+Ta substitution amount 2.6 mol %, as indicated in Nos. 94, 98, and 99 in Table 8, permeability μ′≥1.5 and Q≥20 at 1 GHz are obtained, and the permeability decreases gradually. At Nb+Ta substitution amount=5.2 mol %, Q decreased to Q=16 as indicated in No. 100 in Table 8.

At Fe-site Sb substitution amount 2.6 mol %, as indicated in Nos. 94, 101, and 102 in Table 8, permeability μ′≥1.5 and Q≥20 at 1 GHz are obtained, and the permeability decreases gradually. At Sb substitution amount=5.2 mol %, Q decreased to Q=16 as indicated in No. 103 in Table 8.

At Fe-site W substitution amount≤2.6 mol %, as indicated in Nos. 94, 104, and 105 in Table 8, permeability μ′≥1.5 and Q≥20 at 1 GHz are obtained, and the permeability decreases gradually. At W substitution amount=5.2 mol %, Q decreased to Q=16 as indicated in No. 106 in Table 8.

At Fe-site V substitution amount 2.6 mol %, as indicated in Nos. 94, 107, and 108 in Table 8, permeability μ′≥1.5 and Q≥20 at 1 GHz are obtained, and the permeability decreases gradually. At V substitution amount=5.2 mol %, Q decreased to Q=16 as indicated in No. 109 in Table 8.

### Example 2-7

The values of permeability, magnetic loss, Q, saturation magnetization, coercivity, specific resistance, and dielectric constant of representative examples of compositional formula BaCa_{0.3}Co₂LiₓFe₁₆₋₃ₓSn₂ₓO_{27-δ} are indicated in Table 9.

TABLE 9
Compositional formula: BaCa_{0.3}Co₂LiₓFe₁₆₋₃ₓSn₂ₓO_{27-δ}

| | | | | | | | | | Composite composition | | | | |
|---|---|---|---|---|---|---|---|---|---|---|---|---|---|
| | | Compositional | Compositional ratio | | | | | | amount mol %] | | | | |
| | | formula [mol] | [mol %] | | | | | | Me | Me | Me | Me | |
| No. | | Li x | Ba | Ca | Co | Li | Sn | Fe | (I) | (II) | (IV) | (V) | D |
| 110 | | 0.00 | 5.2 | 1.6 | 10.4 | 0.0 | 0.0 | 82.9 | 0.0 | 10.4 | 0.0 | 0.0 | 10.4 |
| 111 | | 0.25 | 5.2 | 1.6 | 10.4 | 1.3 | 2.6 | 79.0 | 1.3 | 10.4 | 2.6 | 0.0 | 9.1 |
| 112 | | 0.50 | 5.2 | 1.6 | 10.4 | 2.6 | 5.2 | 75.1 | 2.6 | 10.4 | 5.2 | 0.0 | 7.8 |
| 113 | * | 1.00 | 5.2 | 1.6 | 10.4 | 5.2 | 10.4 | 67.4 | 5.2 | 10.4 | 10.4 | 0.0 | 5.2 |

| | Permeability at 1 | | | Magnetization curve | | | |
|---|---|---|---|---|---|---|---|
| | GHz μ = μ′ − μ″ | | | Saturation | Coercivity | Specific | Dielectric |
| | | | Q | magnetization | Hcj | resistance | constant |
| No. | μ′ | μ″ | μ′/μ″ | Is [mT] | [kA/m] | ρ [Ω · m] | ∈ 1 GHz |
| 110 | 2.00 | 0.03 | 67 | 281 | 25 | 2 × 10⁸ | 10 |
| 111 | 1.82 | 0.05 | 36 | 309 | 31 | 3 × 10⁸ | 9 |
| 112 | 1.70 | 0.06 | 28 | 312 | 34 | 3 × 10⁸ | 9 |
| 113 | 1.57 | 0.15 | 10 | 277 | 49 | 4 × 10⁸ | 9 |

At Fe-site Li substitution amount 2.6 mol %, as indicated in Nos. 110 to 112 in Table 9, permeability μ′≥1.5 and Q≥20 at 1 GHz are obtained, and the permeability decreases gradually. At Li substitution amount=5.2 mol %, Q decreased to Q=10 as indicated in No. 113 in Table 9.

### Example 2-8

Values of permeability, magnetic loss, Q, saturation magnetization, coercivity, specific resistance, and dielectric constant of representative examples of compositional formula (Ba₁₋ₓLaₓ) Ca_{0.3} (Co₂Li_{0.5x}) Fe_{16-0.5x}O_{27-δ} are indicated in Table 10.

TABLE 10
Compositional formula: (Ba₁₋ₓLaₓ)Ca_{0.3}(Co₂Li_{0.5x})Fe_{16-0.5x}O_{27-δ}

| | | | | Compositional ratio | | | | | | Composite composition | | | | |
|---|---|---|---|---|---|---|---|---|---|---|---|---|---|---|
| | | Compositional | | [mol %] | | | | | | amount [mol %] | | | | |
| | | formula [mol] | | Ba | | | | Li | | Me | Me | Me | Me | |
| No. | | La x | Li 0.5x | 1 − x | Ca | Co | La x | 0.5x | Fe | (I) | (II) | (IV) | (V) | D |
| 114 | | 0.00 | 0.00 | 5.2 | 1.6 | 10.4 | 0.0 | 0.0 | 82.9 | 0.0 | 10.4 | 0.0 | 0.0 | 10.4 |
| 115 | | 0.20 | 0.10 | 4.1 | 1.6 | 10.4 | 1.0 | 0.5 | 82.4 | 0.5 | 10.4 | 0.0 | 0.0 | 10.9 |
| 116 | | 0.40 | 0.20 | 3.1 | 1.6 | 10.4 | 2.1 | 1.0 | 81.9 | 1.0 | 10.4 | 0.0 | 0.0 | 11.4 |
| 117 | * | 0.50 | 0.25 | 2.6 | 1.6 | 10.4 | 2.6 | 1.3 | 81.6 | 1.3 | 10.4 | 0.0 | 0.0 | 11.7 |
| 118 | * | 0.70 | 0.35 | 1.6 | 1.6 | 10.4 | 3.6 | 1.8 | 81.1 | 1.8 | 10.4 | 0.0 | 0.0 | 12.2 |

| | Permeability at 1 | | | Magnetization curve | | | |
|---|---|---|---|---|---|---|---|
| | GHz μ = μ′ − jμ″ | | | Saturation | Coercivity | Specific | Dielectric |
| | | | Q | magnetization | Hcj | resistance | constant |
| No. | μ′ | μ″ | μ′/μ″ | Is [mT] | [kA/m] | ρ [Ω · m] | ∈ 1 GHz |
| 114 | 2.00 | 0.03 | 67 | 281 | 25 | 2 × 10⁸ | 10 |
| 115 | 1.83 | 0.05 | 37 | 308 | 30 | 3 × 10⁸ | 9 |
| 116 | 1.71 | 0.06 | 29 | 311 | 35 | 3 × 10⁸ | 9 |
| 117 | 1.56 | 0.15 | 10 | 276 | 50 | 4 × 10⁸ | 9 |
| 118 | 1.15 | 0.25 | 5 | 191 | 87 | 4 × 10⁸ | 9 |

At Ba-site La substitution amount 2.1 mol % and Fe-site Li substitution amount 1.0 mol %, as indicated in Nos. 114 to 116 in Table 10, permeability μ′≥1.5 and Q≥20 at 1 GHz are obtained, and the permeability decreases gradually. At La substitution amount=2.6 mol %, Q decreased to Q=10 as indicated in No. 117 in Table 10. At La substitution amount=3.6 mol %, as indicated in No. 118 in Table 10, the permeability and Q decreased to permeability μ′=1.15 and Q=5 at 1 GHz.

### Example 2-9

Values of permeability, magnetic loss, Q, saturation magnetization, coercivity, specific resistance, and dielectric constant of representative examples of compositional formula (Ba₁₋ₓMeₓ)Ca_{0.3}Co₂(Fe₁₆₋ₓSnₓ)O_{27-δ} with Me=Na or K are indicated in Table 11.

TABLE 11
Compositional formula: (Ba₁₋ₓMeₓ)Ca_{0.3}Co₂ (Fe₁₆₋ₓ Snₓ)O_{27-δ}

| | | | | | | | | | | Composite composition | | | | |
|---|---|---|---|---|---|---|---|---|---|---|---|---|---|---|
| | Compositional formula | | Compositional | | | | | | | amount [mol %] | | | | |
| | [mol] Me element | | ratio mol %] | | | | | | | Me | Me | Me | Me | |
| No. | Na x | K x | Ba 1 − x | Ca | Co | Na x | K x | Sn | Fe | (I) | (II) | (IV) | (V) | D |
| 119 | 0.00 | 0.00 | 5.2 | 1.6 | 10.4 | 0.0 | 0.0 | 0.0 | 82.9 | 0.0 | 10.4 | 0.0 | 0.0 | 10.4 |
| 120 | 0.25 | 0.00 | 3.9 | 1.6 | 10.4 | 1.3 | 0.0 | 1.3 | 81.6 | 1.3 | 10.4 | 1.3 | 0.0 | 10.4 |
| 121 | 0.50 | 0.00 | 2.6 | 1.6 | 10.4 | 2.6 | 0.0 | 2.6 | 80.3 | 2.6 | 10.4 | 2.6 | 0.0 | 10.4 |
| 122 | 1.00 | 0.00 | 0.0 | 1.6 | 10.4 | 5.2 | 0.0 | 5.2 | 77.7 | 5.2 | 10.4 | 5.2 | 0.0 | 10.4 |
| 123 | 0.00 | 0.25 | 3.9 | 1.6 | 10.4 | 0.0 | 1.3 | 1.3 | 81.6 | 1.3 | 10.4 | 1.3 | 0.0 | 10.4 |
| 124 | 0.00 | 0.50 | 2.6 | 1.6 | 10.4 | 0.0 | 2.6 | 2.6 | 80.3 | 2.6 | 10.4 | 2.6 | 0.0 | 10.4 |
| 125 | 0.00 | 1.00 | 0.0 | 1.6 | 10.4 | 0.0 | 5.2 | 5.2 | 77.7 | 5.2 | 10.4 | 5.2 | 0.0 | 10.4 |

| | Permeability at 1 | | | Magnetization curve | | | |
|---|---|---|---|---|---|---|---|
| | GHz μ = μ′ − jμ″ | | | Saturation | Coercivity | Specific | Dielectric |
| | | | Q | magnetization | Hcj | resistance | constant |
| No. | μ′ | μ″ | μ′/μ″ | Is [mT] | [kA/m] | ρ [Ω · m] | ∈ 1 GHz |
| 119 | 2.00 | 0.03 | 67 | 281 | 25 | 2 × 10⁸ | 10 |
| 120 | 2.25 | 0.04 | 63 | 285 | 26 | 2 × 10⁸ | 9 |
| 121 | 2.41 | 0.04 | 57 | 290 | 26 | 8 × 10⁷ | 15 |
| 122 | 2.58 | 0.06 | 44 | 300 | 23 | 5 × 10⁷ | 33 |
| 123 | 2.25 | 0.04 | 63 | 285 | 26 | 2 × 10⁸ | 9 |
| 124 | 2.41 | 0.04 | 57 | 290 | 26 | 8 × 10⁷ | 15 |
| 125 | 2.58 | 0.06 | 44 | 300 | 23 | 5 × 10⁷ | 33 |

At Ba-site Na substitution amount≤5.2 mol %, as indicated in Nos. 119 to 122 in Table 11, permeability μ′≥1.5 and Q≥20 at 1 GHz are obtained.

At Ba-site K substitution amount 5.2 mol %, as indicated in Nos. 118 and 123 to 125 in Table 11, permeability μ′≥1.5 and Q≥20 at 1 GHz are obtained.

Note that in Examples 2-1 to 2-9, the maximum major axis diameter of crystal grains was less than 3 μm in all samples.

### Example 3-1

A winding coil was prepared from the obtained calcined powder.

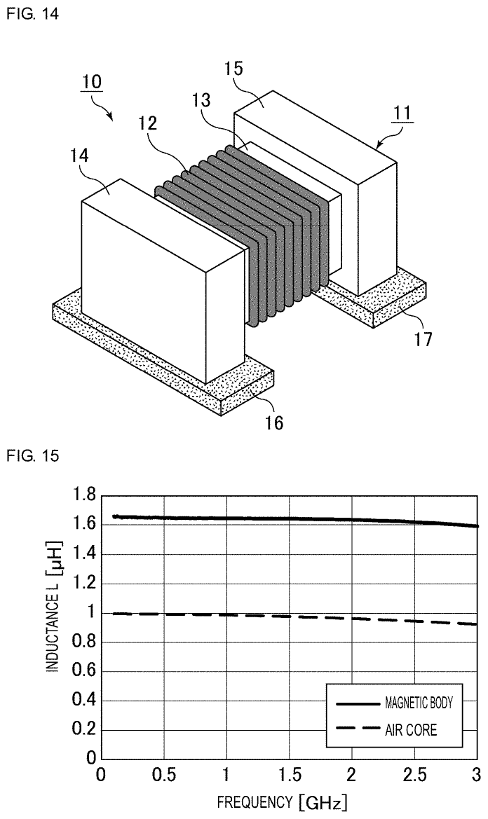

FIG. 14 is a schematic perspective view of one example of a winding coil.

A winding coil 10 illustrated in FIG. 14 is equipped with a core 11, which is a magnetic body. A conductive wire 12 is spirally wound on the core 11. The core 11 is equipped with a barrel 13 on which the conductive wire 12 is wound, and extension portions 14 and 15 respectively disposed at two ends portions of the barrel 13. The extension portions 14 and 15 each have a shape that extends downward and upward from the barrel 13. Terminal electrodes 16 and 17 are respectively formed by plating or the like on lower surfaces of the extension portions 14 and 15. Although not illustrated, the two end portions of the conductive wire 12 are fixed by being thermally welded to the terminal electrodes 16 and 17.

Into a 500 cc polyester pot, 80 g of a hexagonal ferrite calcined powder having a composition of No. 5 in Table 1, 60 to 100 g of pure water, 1 to 2 g of an ammonium polycarboxylate dispersant, and 1000 g of PSZ media having a diameter of 1 to 5 mmϕ were placed, and the resulting mixture was ground for 70 to 100 hours in a ball mill at a rotation rate of 100 to 200 rpm to obtain fine particle slurry. To the fine particle slurry, 5 to 15 g of a binder having a molecular weight of 5000 to 30000 was added, and the resulting mixture was dried in a spray granulator to obtain a granular powder. This powder was press-formed into a core shape of the winding coil illustrated in FIG. 14 so as to obtain a workpiece.

The workpiece was placed on a zirconia setter and heated in air at a temperature elevation rate of 0.1 to 0.5° C./minute at a maximum temperature of 400° C. by holding the maximum temperature for 1 to 2 hours so as to thermally decompose and degrease the vinyl acetate binder and the like, and then fired at a firing temperature selected from 900 to 1100° C. at which the magnetic loss μ″ at 1 GHz is minimum and at a temperature elevation rate of 1 to 5° C./minute and a maximum temperature retaining time of 1 to 5 hours so as to obtained a sintered body. A nonmagnetic body having the same shape was prepared as a comparison.

As illustrated in FIG. 14, electrodes were formed on substrate contact surfaces of the core-shaped sintered body, a copper wire was then wound around the core portion of the sintered body, and two ends of the copper wire was soldered to the electrodes formed on the substrate contact surfaces to obtain a winding coil.

The frequency characteristics of the inductance L of the coil are illustrated in FIG. 15.

As illustrated in FIG. 15, the inductance of the winding coil formed of the magnetic body was about 1.6 times the inductance of an air coil inductor formed of a nonmagnetic body. The possible reason for this is that permeability μ′ of magnetic body=2.0, which is 2.0 times the permeability μ′ of the nonmagnetic body, i.e., permeability μ′=1, and a slight decrease is presumably due to the demagnetizing field in the winding coil.

The frequency characteristics of Q of the coil are illustrated in FIG. 16.

FIG. 16 indicates that Q of the winding coil was higher for the magnetic body up to 2.5 GHz. The possible reason for this is that while the relationship Q=2nfL/R is known on the lower frequency side, the magnetic body has a higher inductance L as indicated in FIG. 15, and thus Q has decayed due to the LC resonance on the high frequency side.

### Example 3-2

The structure of the coil component is not limited to a winding coil, and effects such as a high inductance L similar to that illustrated in FIG. 15 and high Q similar to that illustrated in FIG. 16 can be obtained even from a coil component such as laminated coils.

A sheet was prepared as in Example 1, a coil was formed on a portion of the sheet by printing, and then a pressure-bonded body was produced. The pressure-bonded body was fired as in Example 2 to obtain a sintered body. The surfaces of this sintered body were barrel-finished to expose two end portions of the electrodes, outer electrodes were then formed, and heating was performed to prepare a laminated coil having the shape illustrated in FIG. 17.

FIG. 17 is a schematic perspective view of one example of a laminated coil.

A laminated coil 20 illustrated in FIG. 17 is equipped with a magnetic body 21. A coil-shaped inner electrode 23 that is electrically connected via through holes 22 is formed in the magnetic body 21. Outer electrodes 24 and 25 electrically connected to the coil-shaped inner electrode 23 are formed on surfaces of the magnetic body 21.

### Example 3-3

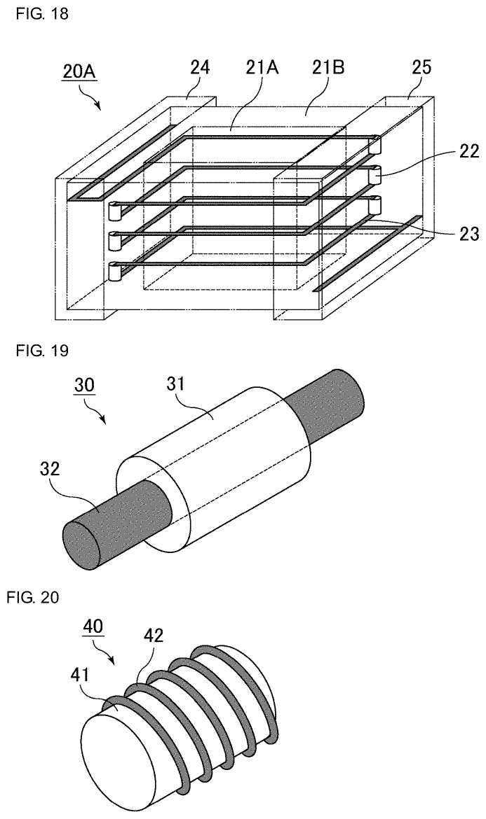

Into a 500 cc polyester pot, 80 g of a hexagonal ferrite calcined powder, 60 to 100 g of pure water, 1 to 2 g of an ammonium polycarboxylate dispersant, and 1000 g of PSZ media having a diameter of 1 to 5 mmϕ were placed, and the resulting mixture was ground for 70 to 100 hours in a ball mill at a rotation rate of 100 to 200 rpm to obtain fine particle slurry. The maximum major axis diameter of the primary particles of the ground powder was 3 μm to 100 μm. To the fine particle slurry, 5 to 15 g of a vinyl acetate binder having a molecular weight of 5000 to 30000 was added, and the resulting slurry was ground by being passed through a three-roll mill to obtain a paste. The paste was poured into only a core portion 21A of a laminated coil 20A illustrated in FIG. 18 and dried to eliminate flowability to thereby prepare a laminated coil.

When a winding portion 21B of the laminated coil 20A illustrated in FIG. 18 is a nonmagnetic body having a low dielectric constant and a magnetic body is inserted into only the core portion 21A, the stray capacitance component between the turns of the winding can be decreased while utilizing the inductance component generated by the magnetic body; thus, the LC resonant frequency can be increased, and thus the coil can function as a wide-band inductor.

FIG. 18 is a schematic perspective view of another example of a laminated coil.

A laminated coil 20A illustrated in FIG. 18 is equipped with a core portion 21A at the center, and a winding portion 21B around the core portion 21A. The core portion 21A is formed of a magnetic body. The winding portion 21B is preferably constituted by a nonmagnetic body and a coil-shaped inner electrode 23, but may be constituted by a magnetic body and a coil-shaped inner electrode 23. The coil-shaped inner electrode 23 that is electrically connected via through holes 22 is formed in the winding portion 21B. Outer electrodes 24 and 25 electrically connected to the coil-shaped inner electrode 23 are formed on surfaces of the winding portion 21B.

### Example 4

The soft magnetic composition of the present invention is not limited to the use in coil components that function as inductors, and can be used in antenna applications that transmit and receive radio waves and that are required to have high permeability μ′ and high Q of a magnetic body.

FIG. 19 is a schematic perspective view of one example of an antenna.

An antenna 30 illustrated in FIG. 19 includes a ring-shaped magnetic body 31 disposed on one part or the entirety of a metal antenna wire 32. The wavelength-reducing effect of the magnetic body can reduce the size of the antenna.

A W-type hexagonal ferrite magnetic granular powder obtained by using a spray granulator was press-formed into a ring shape to obtain a ring-shaped workpiece. The workpiece was placed on a zirconia setter and heated in air at a temperature elevation rate of 0.1 to 0.5° C./minute at a maximum temperature of 400° C. by holding the maximum temperature for 1 to 2 hours so as to thermally decompose and degrease the vinyl acetate binder and the like, and then fired at a firing temperature selected from 900 to 1100° C. at which the magnetic loss μ″ at 1 GHz is minimum and at a temperature elevation rate of 1 to 5° C./minute and a maximum temperature retaining time of 1 to 5 hours so as to obtained a ring-shaped magnetic body 31. The metal antenna wire 32 was passed through a hole in the ring-shaped magnetic body 31 to form an electric cable.

FIG. 20 is a schematic perspective view of another example of an antenna.

An antenna 40 illustrated in FIG. 20 includes a magnetic body 41 and a coil-shaped metal antenna wire 42 around the magnetic body 41. The wavelength-reducing effect of the magnetic body can reduce the size of the antenna.

Furthermore, when an LC resonant circuit is assembled by using the inductor prepared by using the soft magnetic composition of the present invention and a capacitor, signals in a frequency region near the resonant frequency can be absorbed and thus the circuit can also function as a noise filter. Although a noise filter constituted solely by a magnetic body can absorb signals in the entire cellular phone frequency range of 700 MHz to 3.6 GHz, a noise filter constituted by an LC resonant circuit can absorb only signals in a narrow frequency range having a bandwidth of 1 GHz or less, such as a range of 2 to 3 GHz.

### REFERENCE SIGNS LIST

10 winding coil

11 core (magnetic body)

12 conductive wire

13 barrel

14, 15 extension portion

16, 17 terminal electrode

20, 20A laminated coil

21 magnetic body

21A core portion

21B winding portion

22 through hole

23 coil-shaped inner electrode

24, 25 outer electrode

30, 40 antenna

31, 41 magnetic body

32, 42 metal antenna wire

1. A soft magnetic composition comprising:
W-type hexagonal ferrite as a main phase and having metal element ratios of:
a total of Ba+Sr+Na+K+La: 4.7 mol % to 5.8 mol %, where Ba: 0 mol % to 5.8 mol %, Sr: 0 mol % to 5.8 mol %, Na: 0 mol % to 5.2 mol %, K: 0 mol % to 5.2 mol %, and La: 0 mol % to 2.1 mol %;
Ca: 0.2 mol % to 5.0 mol %;
Fe: 72.5 mol % to 86.0 mol %;
Li: 0 mol % to 2.6 mol %;
Co: 7.0 mol % to 15.5 mol %; and
D: 7.0 mol % to 14.8 mol % when: Me(I)=Li+Na+K, Me(II)=Co+Cu+Mg+Mn+Ni+Zn, Me(IV)=Ge+Si+Sn+Ti+Zr+Hf, Me(V)=Mo+Nb+Ta+Sb+W+V, and D=Me(I)+Me(II)−Me(IV)−2×Me(V), where:
Cu: 0 mol % to 2.6 mol %,
Mg: 0 mol % to 2.6 mol %,
Mn: 0 mol % to 2.6 mol %,
Ni: 0 mol % to 5.2 mol %,
Zn: 0 mol % to 2.6 mol %,
Ge: 0 mol % to 2.6 mol %,
Si: 0 mol % to 2.6 mol %,
Ti: 0 mol % to 2.6 mol %,
Sn: 0 mol % to 5.2 mol %,
Zr+Hf: 0 mol % to 5.2 mol %,
Al: 0 mol % to 5.2 mol %,
Ga: 0 mol % to 5.2 mol %,
In: 0 mol % to 7.8 mol %,
Sc: 0 mol % to 7.8 mol %,
Mo: 0 mol % to 2.6 mol %,
Nb+Ta: 0 mol % to 2.6 mol %,
Sb: 0 mol % to 2.6 mol %,
W: 0 mol % to 2.6 mol %, and
V: 0 mol % to 2.6 mol %,
the soft magnetic composition having a coercivity Hcj of 40 kA/m or less.

2. The soft magnetic composition according to claim 1, wherein the metal element ratios are:
Ba: 5.1 mol % to 5.2 mol %,
Ca: 0.5 mol % to 2.6 mol %,
Fe: 82.0 mol % to 83.7 mol %, and
Co: 9.4 mol % to 11.3 mol %, and
the soft magnetic composition has a coercivity Hcj of 30 kA/m or less.

3. The soft magnetic composition according to claim 1, wherein the W-type hexagonal ferrite is a single phase of the soft magnetic composition.

4. The soft magnetic composition according to claim 1, wherein the W-type hexagonal ferrite has a structural formula of A²⁺Me²⁺₂Fe₁₆O₂₇.

5. The soft magnetic composition according to claim 1, wherein a total of Ba+Sr is 4.7 mol % to 5.8 mol %.

6. The soft magnetic composition according to claim 1, wherein the soft magnetic composition has a saturation magnetization Is of 200 mT or more.

7. The soft magnetic composition according to claim 1, wherein a maximum major axis diameter of crystal grains of the W-type hexagonal ferrite is less than 3 μm, and an average crystal grain diameter of the W-type hexagonal ferrite is 0.05 μm to 2 μm.

8. The soft magnetic composition according to claim 1, wherein the soft magnetic composition has a specific resistance ρ of 10⁶ Ω·m or more.

9. The soft magnetic composition according to claim 1, wherein the soft magnetic composition has a permeability μ′ of 1.5 or more.

10. The soft magnetic composition according to claim 1, wherein the soft magnetic composition has a dielectric constant ε of 100 or less.

11. A sintered body comprising the soft magnetic composition according to claim 1 after firing the soft magnetic composition.

12. A sintered body comprising the soft magnetic composition according to claim 2 after firing the soft magnetic composition.

13. A composite body comprising a mixture of the soft magnetic composition according to claim 1 and a non-magnetic body.

14. A composite body comprising a mixture of the soft magnetic composition according to claim 2 and a non-magnetic body.

15. A paste comprising a mixture of the soft magnetic composition according to claim 1 and a non-magnetic body.

16. A paste comprising a mixture of the soft magnetic composition according to claim 2 and a non-magnetic body.

17. A coil component comprising:
a core portion; and
a winding portion disposed around the core portion,
wherein the core portion is a sintered body, a composite body, or a paste formed from the soft magnetic composition according to claim 1, and
the winding portion contains an electrical conductor.

18. A coil component comprising:
a core portion; and
a winding portion disposed around the core portion,
wherein the core portion is a sintered body, a composite body, or a paste formed from the soft magnetic composition according to claim 2, and
the winding portion contains an electrical conductor.

19. An antenna comprising:
a sintered body, a composite body, or a paste formed from the soft magnetic composition according to claim 1; and
an electrical conductor.

20. An antenna comprising:
a sintered body, a composite body, or a paste formed from the soft magnetic composition according to claim 2; and
an electrical conductor.
